(19) United States
(12) Patent Application Publication
(10) Pub. No.: US 2026/0141869 A1
(43) Pub. Date: May 21, 2026

(54) DISPLAY APPARATUS AND METHOD OF CONTROLLING THE SAME

(71) Applicant: SAMSUNG ELECTRONICS CO., LTD., Suwon-si (KR)

(72) Inventors: Sujin KIM, Suwon-si (KR); Jungmo Kang, Suwon-si (KR); Myungjoon Kim, Suwon-si (KR); Hyungjin Kim, Suwon-si (KR); Seungyong Shin, Suwon-si (KR)

(73) Assignee: SAMSUNG ELECTRONICS CO., LTD., Suwon-si (KR)

(21) Appl. No.: 19/382,879

(22) Filed: Nov. 7, 2025

Related U.S. Application Data
(63) Continuation of application No. PCT/KR2025/016546, filed on Oct. 20, 2025.

(30) Foreign Application Priority Data
Nov. 18, 2024 (KR) 10-2024-0164556

(51) Int. Cl. G09G 3/34; G09G 3/32; G09G 3/36

(52) U.S. Cl. CPC G09G 3/3413; G09G 3/32; G09G 3/3426; G09G 3/3648; G09G 2300/0452; G09G 2320/0626; G09G 2320/0666; G09G 2320/0686; G09G 2330/021

(57) ABSTRACT

A display apparatus may include: groups of light-emitting diodes (LEDs), each of the groups of LEDs including a red LED, a green LED, and a blue LED; and a processor configured to control the groups of LEDs. In a color vision deficiency mode, the processor may be configured to: obtain a color difference value between image blocks corresponding to the groups of LEDs; determine at least one from among a current weight of the red LED of a LED group, a current weight of the green LED of the LED group, and a current weight of the blue LED of the LED group, based on the color difference value between the groups of LEDs; and control a current supplied to the at least one from among the red LED, the green LED, and the blue LED, based on the image data and the current weight that is determined.

### CROSS-REFERENCE TO RELATED APPLICATIONS

This application is a bypass continuation application of International Patent Application No. PCT/KR2025/016546, filed on Oct. 20, 2025, which claims priority to Korean Patent Application No. 10-2024-0164556, filed in the Korean Intellectual Property Office on Nov. 18, 2024, the disclosures of which are herein incorporated by reference in their entireties.

### BACKGROUND

### 1. Field

Some embodiments of the present disclosure relate to a display apparatus and a method of controlling the same.

### 2. Brief Description of Background Art

A display apparatus is a type of output apparatus that converts acquired or stored electrical information into visual information to display the visual information for users. The display apparatus is widely used in various fields, such as home or places of business.

A display apparatus may include a backlight unit (BLU) that emits light toward a liquid crystal panel, and the backlight unit may include a plurality of light emitting devices that may independently emit light. The light emitting devices include, for example, light emitting diodes (LEDs) or organic light emitting diodes (OLEDs).

A display apparatus such as, for example, a quantum-dot light emitting diode (QLED) may implement red, green, blue (RGB) colors by using a blue LED as a backlight unit and passing the light through quantum dot sheets and a color filter.

For individuals with color vision deficiency, even when a display apparatus reproduces color images close to actual colors, the images displayed on the display apparatus may not be clearly distinguished due to the color vision deficiency. A color vision deficiency filter function may adjust specific colors more intensely, enabling individuals with color vision deficiency to more easily recognize the corresponding colors.

To implement the color vision deficiency filter function, the current of blue LEDs may be first increased to generate stronger light. This strong blue light may be converted into red light and green light through the quantum dot sheet. This may increase the intensity of colors that individuals with color vision deficiency recognize and improve color contrast on the screen. Additionally, adjustment of color filters and liquid crystal layers may allow specific colors to be expressed more distinctly. By adjusting the transmittance of liquid crystals, more red or green light may be transmitted, thereby enhancing color perception. Such adjustments may contribute to enabling individuals with color vision deficiency to more easily recognize the corresponding colors.

However, this approach has limitations. For example, when attempting to express red color more intensely, the current of blue LEDs is increased to make red light be expressed more strongly. In this process, as the output of blue LEDs increased, unwanted blue light and green light also became brighter together, resulting in reduced luminous efficiency and unnecessary power consumption.

### SUMMARY

According to some embodiments of the present disclosure, a display apparatus and a method of controlling the same capable of more effectively implementing a color vision deficiency filter function by controlling the current of each LED in a display apparatus using RGB LEDs as a light sources may be provided.

Aspects of embodiments of the present disclosure are is not limited to the above-mentioned aspect, and other aspects not mentioned of embodiments of the present disclosure will be clearly understood by one of ordinary skill in the technical art to which the present disclosure belongs from the following description.

According to some embodiments of the present disclosure, a display apparatus may include: an image display portion; a backlight unit configured to provide light to the image display portion; and at least one processor configured to cause the display apparatus to display an image by controlling the image display portion and the backlight unit, wherein the backlight unit includes: a substrate; and a plurality of dimming blocks arranged in a plurality of rows and a plurality of columns on the substrate, the plurality of dimming blocks each including a red light-emitting diode (LED), a green LED, and a blue LED, and wherein, in a color vision deficiency mode, the at least one processor is configured to: obtain, based on image data, a color difference value between a plurality of image blocks of the image, the plurality of image blocks corresponding to the plurality of dimming blocks; determine at least one from among a current weight of the red LED of a dimming block from among the plurality of dimming blocks, a current weight of the green LED of the dimming block, and a current weight of the blue LED of the dimming block, based on the color difference value between the plurality of image blocks; and control a current supplied to the at least one from among the red LED of the dimming block, the green LED of the dimming block, and the blue LED of the dimming block, based on the image data and the current weight that is determined.

According to some embodiments of the present disclosure, a method of controlling a display apparatus to display an image may include: obtaining, in a color vision deficiency mode and based on image data, a color difference value between a plurality of image blocks of the image, the plurality of image blocks corresponding to a plurality of dimming blocks of the display apparatus, and the plurality of dimming blocks each including a red light-emitting diode (LED), a green LED, and a blue LED; determining at least one from among a current weight of the red LED of a dimming block from among the plurality of dimming blocks, a current weight of the green LED of the dimming block, and a current weight of the blue LED of the dimming block, based on the color difference value between the plurality of image blocks; and controlling a current supplied to the at least one from among the red LED of the dimming block, the green LED of the dimming block, and the blue LED of the dimming block, based on the image data and the current weight that is determined.

According to some embodiments of the present disclosure, a display apparatus may include: a plurality of groups of light-emitting diode (LEDs), each of the plurality of groups of LEDs including a red LED, a green LED, and a blue LED; and at least one processor configured to cause the display apparatus to display an image by controlling the plurality of groups of LEDs, wherein, in a color vision deficiency mode, the at least one processor is configured to: obtain, based on image data, a color difference value between a plurality of image blocks of the image, the plurality of image blocks corresponding to the plurality of groups of LEDs; determine at least one from among a current weight of the red LED of a LED group from among the plurality of groups of LEDs, a current weight of the green LED of the LED group, and a current weight of the blue LED of the LED group, based on the color difference value between the plurality of groups of LEDs; and control a current supplied to the at least one from among the red LED of the LED group, the green LED of the LED group, and the blue LED of the LED group, based on the image data and the current weight that is determined.

### BRIEF DESCRIPTION OF DRAWINGS

FIG. 1 shows an example of an appearance of a display apparatus according to an embodiment.

FIG. 2 shows an example of a structure of a display apparatus according to an embodiment.

FIG. 3 shows an example of a liquid crystal panel included in a display apparatus according to an embodiment.

FIG. 4 shows an example of a backlight unit (BLU) included in a display apparatus according to an embodiment.

FIG. 5 is a view for describing a state in which a plurality of light-emitting diodes of a back light unit of a display apparatus according to an embodiment are divided into dimming blocks.

FIG. 6 is a control block diagram of a display apparatus according to an embodiment.

FIG. 7 shows an example of converting image data into dimming data, performed by a display apparatus according to an embodiment.

FIG. 8 shows an example of a light emitting device included in a backlight unit in a display apparatus according to an embodiment.

FIG. 9 is a view for describing an image output using a backlight unit that includes light emitting diodes (LEDs) of a plurality of colors in a display apparatus according to an embodiment.

FIG. 10 shows an arrangement of a dimming driver, a driving device, and a light emitting device, included in a display apparatus according to an embodiment.

FIG. 11 shows an arrangement of a dimming driver, a driving device, and a light emitting device, included in a display apparatus according to an embodiment.

FIG. 12 shows image blocks of an image in a normal mode of a display apparatus according to an embodiment.

FIG. 13 shows image blocks of an image in a color vision deficiency mode of a display apparatus according to an embodiment.

FIG. 14A shows changes in current values of RGB LEDs in a first image block of an image in a normal mode and in a red color vision deficiency mode of a display apparatus according to an embodiment.

FIG. 14B shows changes in current values of RGB LEDs in a second image block of an image in a normal mode and in a red color vision deficiency mode of a display apparatus according to an embodiment.

FIG. 15A is a first view for comparing operations of performing local dimming in a display apparatus according to an embodiment.

FIG. 15B is a second view for comparing operations of performing local dimming in a display apparatus according to an embodiment.

FIG. 16 shows an example of a flowchart of a method of controlling a display apparatus according to an embodiment.

FIG. 17 shows an example of a flowchart for obtaining color difference data in a display apparatus according to an embodiment.

FIG. 18 shows an example of a flowchart for determining current weights in a display apparatus according to an embodiment.

FIG. 19 shows an example of a flowchart for controlling current of RGB LEDs by applying current weights in a display apparatus according to an embodiment.

FIG. 20 is a view for describing selection of a color vision deficiency mode in a display apparatus according to an embodiment.

FIG. 21 is a view for describing execution of a color vision deficiency mode in a display apparatus according to an embodiment.

### DETAILED DESCRIPTION

Example embodiments described in the present disclosure and the terms used in the present disclosure are non-limiting examples, and the present disclosure should be understood to include various modifications, equivalents, and/or alternatives to the corresponding embodiments.

In addition, the same reference numerals or signs shown in the drawings of the present disclosure indicate elements or components performing substantially the same function.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

Terms such as “unit,” “module,” and “member” may be embodied as hardware or software. According to embodiments, a plurality of “unit,” “module,” and “member” may be implemented as a single component or a single “unit,” “module,” and “member” may include a plurality of components.

Also, the terms used herein are used to describe example embodiments and are not intended to limit and/or restrict the present disclosure. The singular forms “a,” “an” and “the” are intended to include the plural forms as well, unless the context clearly indicates otherwise. In the present disclosure, the terms “including,” “having,” and the like are used to specify features, numbers, steps, operations, elements, components, or combinations thereof, but do not preclude the presence or addition of one or more of the features, numbers, steps, operations, elements, components, or combinations thereof.

It will be understood that, although the terms “first,” “second,” “third,” etc., may be used herein to describe various elements, elements are not limited by these terms. These terms are only used to distinguish one element from another element. For example, without departing from the scope of the present disclosure, a first element may be termed as a second element, and a second element may be termed as a first element. The term of “and/or” includes a plurality of combinations of relevant items or any one item among a plurality of relevant items.

When one (e.g., a first) element is referred to as being “coupled” or “connected” to another (e.g., a second) element with or without the term “functionally” or “communicatively,” it means that the one element is connected to the other element directly, wirelessly, or via a third element.

It will be understood that when a certain component is referred to as being “connected to,” “coupled to,” “supported by,” or “in contact with” another component, it may be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” another component, it may be directly on the other component or intervening components may also be present.

In the following detailed description, the terms of “up and down direction,” “front and rear direction” and the like may be defined based on the drawings, but the shape and the location of elements are not limited by the term. For example, the terms “front” and “rear” below may each be defined based on the X direction shown in the drawings. The terms “upward” and “downward” below may each be defined based on the Z direction shown in the drawing. The terms “left direction” and “right direction” below may be defined based on the Y direction shown in the drawing. The term “vertical direction” below may refer to the Z direction shown in the drawings, and the term “horizontal direction” below may refer to the Y direction shown in the drawings.

Hereinafter, non-limiting example embodiments of the present disclosure will be described in detail with reference to the accompanying drawings.

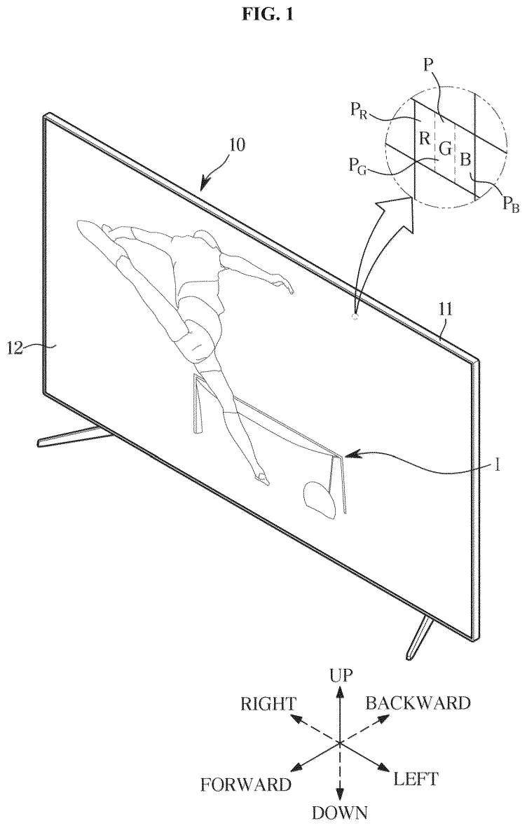

FIG. 1 shows an example of an appearance of a display apparatus according to an embodiment.

Referring to FIG. 1, a display apparatus 10 may process an image signal received from outside to generate an image and visually display the processed image. Hereinafter, the display apparatus 10 is assumed to be a television (TV). However, the display apparatus 10 may be implemented as, for example, one of various apparatuses, such as a monitor, a portable multimedia apparatus, a portable communication apparatus, etc. That is, the display apparatus 10 may be any kind of apparatus that visually displays images.

Also, the display apparatus 10 may be a large format display (LFD) that is installed in an outdoor space, such as the top of building or a bus stop. The outdoor space is not limited to open-air spaces, and the display apparatus 10 according to an embodiment of the present disclosure may be installed in any place where many people come in and out, such as a subway station, a shopping mall, a theater, an office, a store, etc., although the place is an indoor space.

The display apparatus 10 may receive content including a video signal and an audio signal from various content sources, and output video and audio corresponding to the video signal and audio signal. For example, the display apparatus 10 may receive content data through a broadcasting reception antenna or a wired cable, receive content data from a content reproducing apparatus, or receive content data from a content providing server of a content provider.

As shown in FIG. 1, the display apparatus 10 may include a main body 11 and a screen 12 that displays an image I.

The main body 11 may form an appearance of the display apparatus 10. Components may be installed inside the main body 11 to enable the display apparatus 10 to display an image I or perform various functions. The main body 11 shown in FIG. 1 may be in a shape of a flat plate. However, the shape of the main body 11 is not limited to the shape shown in FIG. 1. For example, the main body 11 may be in a shape of a curved plate.

The screen 12 may be formed on a front surface of the main body 11 and display an image I. For example, the screen 12 may display a still image or a moving image. Also, the screen 12 may display a two-dimensional image or a three-dimensional image using a user's binocular disparity.

The screen 12 may include a liquid crystal panel for transmitting or blocking light emitted from a backlight unit (BLU), etc.

In the screen 12, a plurality of pixels P may be formed. An image I displayed on the screen 12 may be formed by light emitted from the plurality of pixels P. For example, light emitted from the plurality of pixels P may be combined like a mosaic to form an image I on the screen 12.

Each of the plurality of pixels P may emit light having various luminance and various colors. To emit light having various colors, each of the plurality of pixels P may include a plurality of sub pixels.

The sub pixels may include a red sub pixel PR capable of emitting red light, a green sub pixel PG capable of emitting green light, and a blue sub pixel PB capable of emitting blue light. For example, the red light may correspond to light of a wavelength range from about 700 nanometer (nm, one billionth of a meter) to about 800 nm, the green light may correspond to light of a wavelength range from about 500 nm to about 600 nm, and the blue light may correspond to light of a wavelength range from about 400 nm to about 500 nm.

Each of the plurality of pixels P may emit light having various luminance and various colors by a combination of red light from the red sub pixel PR, green light from the green sub pixel PG, and blue light from the blue sub pixel PB.

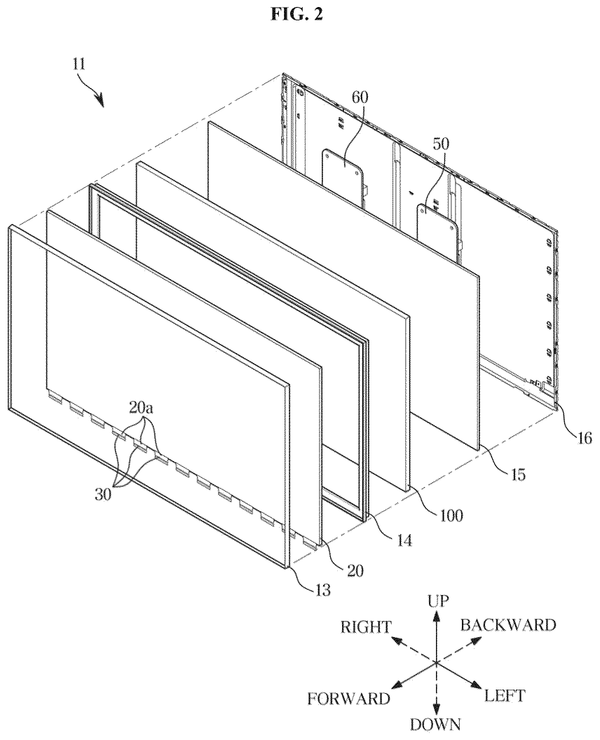

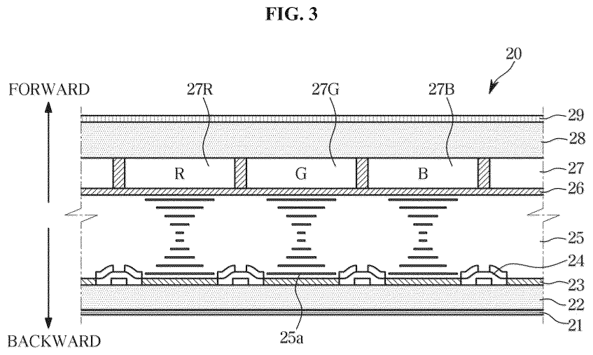

FIG. 2 shows an example of a structure of the display apparatus according to an embodiment, and FIG. 3 shows an example of a liquid crystal panel included in the display apparatus according to an embodiment.

Referring to FIG. 2, various components for displaying an image I on the screen \may be installed inside the main body 11.

For example, a backlight unit 100 being a surface light source, a liquid crystal panel 20 for transmitting or blocking light emitted from the backlight unit 100, a control assembly 50 for controlling operations of the backlight unit 100 and the liquid crystal panel 20, and a power assembly 60 for supplying power to the backlight unit 100 and the liquid crystal panel 20 may be provided in the main body 11. Also, the main body 11 may include a bezel 13, a frame middle mold 14, a bottom chassis 15, and a rear cover 16 for supporting the liquid crystal panel 20, the backlight unit 100, the control assembly 50, and the power assembly 60.

The backlight unit 100 may include a point light source for emitting white light. Also, the backlight unit 100 may refract, reflect, and scatter light emitted from the point light source to convert the light into uniform surface light. As described above, the backlight unit 100 may emit uniform surface light toward a front direction by refracting, reflecting, and scattering light emitted from the point light source.

The backlight unit 100 will be described in more detail below.

The liquid crystal panel 20, as a display panel, may be positioned in front of the backlight unit 100, and block or transmit light emitted from the backlight unit 100 to form an image I. The liquid crystal panel 20 may include an image display portion for displaying the image I.

A front surface of the liquid crystal panel 20 may form the above-described screen of the display apparatus 10, and the liquid crystal panel 20 may form the plurality of pixels P. Each of the plurality of pixels P of the liquid crystal panel 20 may independently block or transmit light emitted from the backlight unit 100. Also, light transmitted by the plurality of pixels P may form an image I that is displayed on the screen.

For example, as shown in FIG. 3, the liquid crystal panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The first transparent substrate 22 and the second transparent substrate 28 may fix and support the pixel electrode 23, the thin film transistor 24, the liquid crystal layer 25, the common electrode 26, and the color filter 27. The first transparent substrate 22 and the second transparent substrate 28 may be made of tempered glass or a transparent resin.

The first polarizing film 21 and the second polarizing film 29 may be respectively positioned on outer surfaces of the first transparent substrate 22 and the second transparent substrate 28. The first polarizing film 21 and the second polarizing film 29 may transmit specific polarized light and block (reflect or absorb) the other polarized light. For example, the first polarizing film 21 may transmit polarized light traveling toward a first direction and block (reflect or absorb) the other polarized light. Also, the second polarizing film 29 may transmit polarized light traveling toward a second direction and block (reflect or absorb) the other polarized light, wherein the second direction may be orthogonal to the first direction. Accordingly, polarized light transmitted by the first polarizing film 21 may not be directly transmitted through the second polarizing film 29.

The color filter 27 may be provided on an inner side of the second transparent substrate 28. The color filter 27 may include, for example, a red filter 27R configured to transmit red light, a green filter 27G configured to transmit green light, and a blue filter 27G configured to transmit blue light. Also, the red filter 27R, the green filter 27G, and the blue filter 28B may be arranged side by side. An area occupied by the color filter 27 may correspond to a pixel P described above. An area occupied by the red filter 27R may correspond to a red sub pixel PR, an area occupied by the green filter 27G may correspond to a green sub pixel PG, and an area occupied by the blue filter 27B may correspond to a blue sub pixel PB.

The pixel electrode 23 may be provided on an inner side of the first transparent substrate 22, and the common electrode 26 may be provided on the inner side of the second transparent substrate 28. The pixel electrode 23 and the common electrode 26 may be made of a metal material carrying electricity, and form an electric field for changing an arrangement of liquid crystal molecules 25a configuring the liquid crystal layer 25 which will be described below.

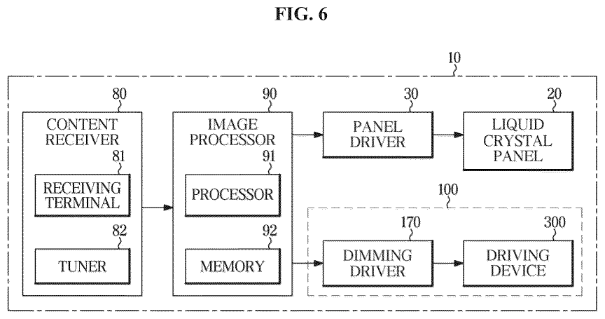

The thin film transistor 24 may be positioned on the inner surface of the first transparent substrate 22. The thin film transistor 24 may be turned on (closed) or turned off (opened) by image data provided from a panel driver 30 (see FIG. 6). Also, according to turning-on (closing) or turning-off (opening) of the thin film transistor 24, an electric field may be formed or removed between the pixel electrode 23 and the common electrode 26.

The liquid crystal layer 25 may be formed between the pixel electrode 23 and the common electrode 26, and the liquid crystal layer 25 may be filled with the liquid crystal molecules 25a. Liquid crystal is in an intermediate state between a solid (crystal) state and a liquid state. The liquid crystal shows an optical property according to a change in electric field. For example, the direction of the molecular arrangement of liquid crystal changes according to a change in electric field. As a result, the optical property of the liquid crystal layer 25 may change according to the presence/absence of an electric field passing through the liquid crystal layer 25. For example, the liquid crystal layer 25 may rotate a polarizing direction of light with respect to an optical axis according to presence/absence of an electric field. Thereby, a polarizing direction of polarized light passed through the first polarizing film 21 may rotate while the polarized light passes through the liquid crystal layer 25, and then the resultant polarized light may pass through the second polarizing film 29.

At one edge of the liquid crystal panel 20, a cable 20a for transmitting image data to the liquid crystal panel 20, and a display driver integrated circuit (DDI) (hereinafter, referred to as a “panel driver”) for processing digital image data and outputting an analog image signal may be provided.

The cable 20a may electrically connect the control assembly 50 and/or the power assembly 60 to the panel driver 30, and also electrically connect the panel driver 30 to the liquid crystal panel 20. The cable 20a may include a flexible flat cable or a film cable.

The panel driver 30 may receive image data and power from the control assembly 50 and/or the power assembly 60 through the cable 20a. Also, the panel driver 30 may provide image data and driving current to the liquid crystal panel 20 through the cable.

Also, the cable 20a and the panel driver 30 may be integrated into one body and implemented as a film cable, a chip on film (COF), a tape carrier package (TCP), etc. In other words, the panel driver 30 may be positioned on the cable 20a, although not limited thereto. However, the panel driver 30 may be positioned on the liquid crystal panel 20.

The control assembly 50 may include a control circuit for controlling operations of the liquid crystal panel 20 and the backlight unit 100. For example, the control circuit may process a video signal and/or an audio signal received from an external content source. The control circuit may transmit image data to the liquid crystal panel 20 and transmit dimming data to the backlight unit 100.

The power assembly 60 may include a power circuit for supplying power to the liquid crystal panel 20 and the backlight unit 100. The power circuit may supply power to the control assembly 50, the backlight unit 100, and the liquid crystal panel 20.

The control assembly 50 and the power assembly 60 may be implemented with a printed circuit board and various kinds of circuits mounted on the printed circuit board. For example, the power circuit may include a capacitor, a coil, a resistor device, a processor, and a power circuit board on which the capacitor, the coil, the resistor device, and the processor are mounted. Also, the control circuit may include a memory, a processor, and a control circuit board on which the memory and the processor are mounted.

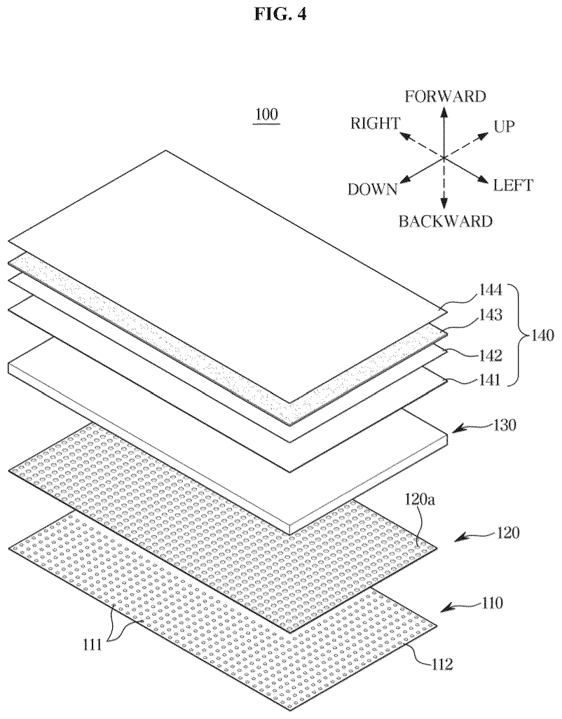

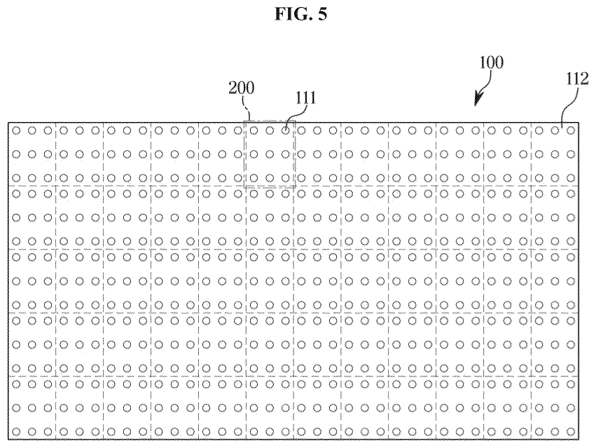

FIG. 4 shows an example of the backlight unit 100 included in a display apparatus according to an embodiment, and FIG. 5 is a view for describing dimming blocks divided from a plurality of light emitting diodes (LEDs) of the backlight unit in a display apparatus according to an embodiment.

Referring to FIG. 4, the backlight unit 100 may include a light source module 110 for generating light, a reflective sheet 120 for reflecting light, a diffuser plate 130 for uniformly diffusing light, and an optical sheet 140 for improving luminance of exit light.

The light source module 110 may include a plurality of light emitting devices 111 for emitting light, and a substrate 112 for supporting/fixing the plurality of light emitting devices 111.

The plurality of light emitting devices 111 may be arranged in a preset pattern to emit light with uniform luminance. The plurality of light emitting devices 111 may be arranged such that distances between each light emitting device and the neighboring light emitting devices are the same.

For example, as shown in FIG. 4, the plurality of light emitting devices 111 may be arranged in regular rows and columns. For example, the plurality of light emitting devices 111 may be arranged such that four neighboring light emitting devices form substantially a square. Also, any one light emitting device may be adjacent to four light emitting devices, and distances between the light emitting device and the four adjacent light emitting devices may be substantially the same.

Also, according to some embodiments, the plurality of light emitting devices 111 may be arranged such that three neighboring light emitting devices form substantially an equilateral triangle. In this case, one light emitting device may be adjacent to six light emitting devices, and, also, distances between the light emitting device and the six adjacent light emitting devices may be substantially the same.

However, an arrangement of the plurality of light emitting devices 111 is not limited to the above-described arrangement, and the plurality of light emitting devices 111 may be arranged in various ways to emit light with uniform luminance.

The light emitting device 111 may include a LED. The LED may have various sizes, and for example, the LED may include a mini LED and/or a micro LED.

The substrate 112 may fix the plurality of light emitting devices 111 to prevent the light emitting devices 111 from moving. Also, the substrate 112 may supply power for enabling the light emitting devices 111 to emit light to the individual light emitting devices 111.

The substrate 112 may include a synthetic resin and/or tempered glass and/or a printed circuit board (PCB), on which a conductive power supply line for fixing the plurality of light emitting devices 111 and supplying power to the light emitting devices 111 is formed.

Also, the substrate 112 may include a plurality of sub substrates.

The reflective sheet 120 may reflect light emitted from the plurality of light emitting devices 111 toward the front direction or toward an approximately front direction.

In the reflective sheet 120, a plurality of through holes 120a may be formed at locations respectively corresponding to the plurality of light emitting devices 111 of the light source module 110. Also, the light emitting devices 111 of the light source module 110 may pass through the through holes 120a, and protrude forward from the reflective sheet 120.

For example, during an assembly process of the reflective sheet 120 and the light source module 110, the plurality of light emitting devices 111 of the light source module 110 may be inserted into the plurality of through holes 120a formed in the reflective sheet 120. Therefore, although the substrate 112 of the light source module 110 is located behind the reflective sheet 120, at least a portion of the plurality of light emitting devices 111 of the light source module 110 may be located in front of the reflective sheet 120.

Accordingly, the plurality of light emitting devices 111 may emit light in front of the reflective sheet 120.

The plurality of light emitting devices 111 may emit light in various directions in front of the reflective sheet 120. Light may be emitted toward the diffuser plate 130 from the light emitting devices 111 and toward the reflective sheet 120 from the light emitting devices 111. The reflective sheet 120 may reflect light emitted toward the reflective sheet 120 toward the diffuser plate 130.

Light emitted from the light emitting devices 111 may pass through various objects, such as the diffuser plate 130, the optical sheet 140, etc. While light passes through the diffuser plate 130 and the optical sheet 140, a part of the light may be reflected from surfaces of the diffuser plate 130 and the optical sheet 140. The reflective sheet 120 may reflect light reflected by the diffuser plate 130 and the optical sheet 140.

The diffuser plate 130 may be provided in front of the light source module 110 and the reflective sheet 120 and may uniformly disperse light emitted from the light emitting devices 111 of the light source module 110.

The plurality of light emitting devices 111 may be positioned at a plurality of locations in a rear portion of the backlight unit 100, as described above. Although the plurality of light emitting devices 111 may be arranged at equidistant intervals in the rear portion of the backlight unit 100, luminance non-uniformity may occur according to the locations of the plurality of light emitting devices 111.

The diffuser plate 130 may diffuse light emitted from the plurality of light emitting devices 111 in the inside to remove luminance non-uniformity caused by the plurality of light emitting devices 111. In other words, the diffuser plate 130 may uniformly emit non-uniform light emitted from the plurality of light emitting device 111 through the front surface.

The optical sheet 140 may include various sheets for improving luminance and uniformity of luminance. For example, the optical sheet 140 may include a diffuser sheet 141, a first prism sheet 142, a second prism sheet 143, and a reflective polarizing sheet 144.

The diffuser sheet 141 may diffuse light for luminance uniformity. Light emitted from the light emitting devices 111 may be diffused by the diffuser plate 130 and then again diffused by the diffuser sheet 141 included in the optical sheet 140.

The first prism sheet 142 and the second prism sheet 143 may concentrate the light diffused by the diffusing sheet 141 to increase luminance. The first prism sheet 142 and the second prism sheet 143 may include a prism pattern being in a shape of a trigonal prism, and a plurality of prism patterns may be arranged adjacent to each other, thereby forming a plurality of bands.

The reflective polarizing sheet 144 may be a kind of a polarizing film to transmit a part of incident light and reflect the other part of the incident light to improve luminance. For example, the reflective polarizing sheet 144 may transmit polarized light traveling in a preset polarization direction of the reflective polarizing sheet 144 and reflect polarized light traveling in a polarization direction that is different from the preset polarization direction of the reflective polarizing sheet 144. Also, light reflected by the reflective polarizing sheet 144 may be recycled inside the backlight unit 100, and luminance of the display apparatus 10 may be improved by such light recycle.

The optical sheet 140 is not limited to the sheets or films shown in FIG. 4, and may include various sheets or films, such as a protection sheet, etc.

The backlight unit 100 may include the plurality of light emitting devices 111, and diffuse light emitted from the plurality of light emitting devices 111 to output surface light. The liquid crystal panel 20 may include a plurality of pixels, and control each of the plurality of pixels to transmit or block light. An image may be formed by light that has passed through each of the plurality of pixels.

The display apparatus 10 may perform local dimming to vary luminance of light for each area of the backlight unit 100 in conjunction with an output image to improve power consumption while increasing a contrast ratio.

For example, the display apparatus 10 may decrease luminance of light emitted from light emitting devices 111 of the backlight unit 100 corresponding to a dark area of an image to make the dark area darker, and to make a bright area of the image brighter, the display apparatus 10 may increase luminance of light emitted from light emitting devices 111 of the backlight unit 100 corresponding to the bright area of the image. Therefore, a contrast ratio or luminance ratio of the image may be improved.

The display apparatus 10 may divide the backlight unit 100 into a plurality of blocks and adjust current independently for each block according to an input image. Image transmission of the display apparatus 10 may be performed through frame-based local dimming driving, and driving of current may be controlled according to the number of blocks of the light emitting devices 111 in the backlight unit 100.

As a result, the display apparatus 10 may supply less current to dimming blocks corresponding to a dark area of an input image and supply more current to dimming blocks corresponding to a bright area of the image, thereby effectively improving a contrast ratio.

For local dimming, the plurality of light emitting devices 111 included in the backlight unit 100 may be divided into a plurality of dimming blocks 200. For example, the plurality of dimming blocks 200 may be configured in a total of 60, configured with 5 rows and 12 columns, as shown in FIG. 5. As another example, the plurality of dimming blocks 200 may be configured in a total of 20, configured with 5 rows and 4 columns. However, the number of the dimming blocks 200 is not limited to these examples.

Referring to FIG. 5, each of the plurality of dimming blocks 200 may include one or more light emitting devices 111. The backlight unit 100 may supply the same driving current to the light emitting devices 111 belonging to the same dimming block 200, and the light emitting devices 111 belonging to the same dimming block 200 may emit light having the same luminance.

Also, the backlight unit 100 may supply different driving current to light emitting devices 111 belonging to different dimming blocks 200 according to dimming data, and the light emitting devices 111 belonging to the different dimming blocks 200 may emit light having different luminance.

Each of the plurality of dimming blocks 200 may include N*M light sources arranged in a N*M matrix form (N and M are natural numbers). The N*M matrix may be a matrix having N rows and M columns.

Because each of the light emitting devices 111 may include a LED, each of the plurality of dimming blocks 200 may include N*M LEDs. That is, each of the plurality of dimming blocks 200 may include a preset number of light emitting devices 111.

The plurality of dimming blocks 200 may be positioned on the substrate 112. That is, the N*M LEDs may be positioned on the substrate 112. Alternatively, the plurality of dimming blocks 200 may be positioned on a plurality of sub substrates included in the substrate 112. According to some embodiments, the N*M LEDs (e.g., a dimming block 200) may also be referred to as a group of LEDs.

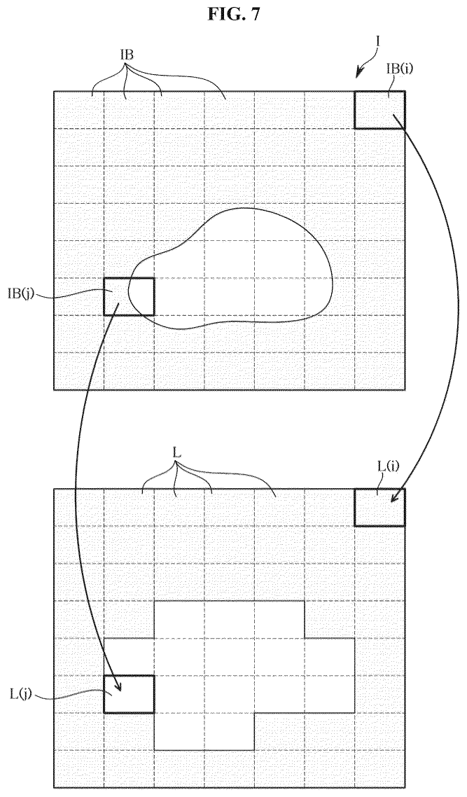

FIG. 6 is a control block diagram of a display apparatus according to an embodiment, and FIG. 7 shows an example of converting image data into dimming data, performed by a display apparatus according to an embodiment.

Referring to FIG. 6, the display apparatus 10 may include a content receiver 80, an image processor 90, the panel driver 30, the liquid crystal panel 20, and the backlight unit 100. In this case, the backlight unit 100 may include a dimming driver 170 that performs local dimming, and a driving device 300 that drives the light emitting devices 111. The driving device 300 may be positioned on an upper or lower surface of the substrate 112.

The content receiver 80 may include a receiving terminal 81 for receiving a video signal and/or an audio signal from content sources, and a tuner 82.

The receiving terminal 81 may receive a video signal and an audio signal from the content sources through a cable. For example, the receiving terminal 81 may include a component (YPbPr/RGB) terminal, a composite video blanking and sync (CVBS) terminal, an audio terminal, a High Definition Multimedia Interface (HDMI) terminal, an Universal Serial Bus (USB) terminal, etc.

The tuner 82 may receive broadcasting signals from a broadcasting reception antenna or a wired cable and extract a broadcasting signal of a channel selected by a user from among the broadcasting signals. For example, the tuner 82 may pass a broadcasting signal having a frequency corresponding to a channel selected by a user among a plurality of broadcasting signals received through the broadcasting reception antenna or the wired cable, and block broadcasting signals having the other frequencies.

As described above, the content receiver 80 may receive an image including a video signal and an audio signal from the content sources through the receiving terminal 81 and/or the tuner 82, and output the image received through the receiving terminal 81 and/or the tuner 82 to the image processor 90.

The image processor 90 may include at least one processor 91 that processes an input image (image data), and memory 92 that stores data.

The memory 92 may store a program and data for processing a video signal and/or an audio signal, and temporarily memorize data generated while processing the video signal and/or the audio signal. According to some embodiments, the memory may store computer instructions that are configured to, when executed by the at least one processor 91, cause the image processor 90 (e.g., the at least one processor 91) to perform its functions.

The memory 92 may include a non-volatile memory, such as Read Only Memory (ROM) and a flash memory, and a volatile memory, such as Static Random Access Memory (S-RAM) and Dynamic Random Access Memory (D-RAM).

The at least one processor 91 may receive an input image including a video signal and/or an audio signal from the content receiver 80, decode the video signal to generate image data, and generate dimming data from the image data. The image data and the dimming data may be output to the panel driver 30 and the dimming driver 170.

The at least one processor 91 may provide dimming data for local dimming to the backlight unit 100. The dimming data may include information about luminance of each of the plurality of dimming blocks 200. For example, the dimming data may include information about an intensity of light output from the light emitting devices 111 included in each of the plurality of dimming blocks 200. That is, the dimming data may include information about a magnitude of current that is supplied to the light emitting devices 111 included in each of the plurality of dimming blocks 200.

The at least one processor 91 may obtain the dimming data from the image data decoded from the video signal.

The at least one processor 91 may convert image data into dimming data by various methods. For example, as shown in FIG. 7, the at least one processor 91 may divide an image I formed by image data into a plurality of image blocks IB. The number of the plurality of image blocks IB may be equal to the number of the plurality of dimming blocks 200, and the plurality of image blocks IB may respectively correspond to the plurality of dimming blocks 200.

The at least one processor 91 may obtain luminance values L of the plurality of dimming blocks 200 from image data of the plurality of image blocks IB. Also, the at least one processor 91 may generate dimming data by combining the luminance values L of the plurality of dimming blocks 200.

For example, the at least one processor 91 may obtain a luminance value L of each of the plurality of dimming blocks 200 based on a maximum value of luminance values of pixels included in each of the image blocks IB.

An image block may include a plurality of pixels, and image data of the image block may include image data (e.g., red data, green data, blue data, etc.) of the plurality of pixels. The at least one processor 91 may calculate a luminance value of each pixel based on image data of the pixel.

The at least one processor 91 may set a maximum value of luminance values of pixels included in an image block IB to a luminance value of a dimming block 200 corresponding to the image block IB. For example, the processor 91 may set a maximum value of luminance values of pixels included in an i-th image block IB (i) to a luminance value L (i) of an i-th dimming block, and set a maximum value of luminance values of pixels included in a j-th image block IB (j) to a luminance value L (j) of a j-th dimming block.

The at least one processor 91 may generate dimming data by combing luminance values of the plurality of dimming blocks 200.

As described above, the image processor 90 may decode a video signal obtained by the content receiver 80 to generate image data and generate dimming data from the image data. Also, the image processor 90 may transmit the image data and the dimming data to the liquid crystal panel 20 and the light source device 100, respectively.

The liquid crystal panel 20 may include a plurality of pixels capable of transmitting or blocking light, and the plurality of pixels may be arranged in a matrix form. In other words, the plurality of pixels may be arranged in a plurality of rows and a plurality of columns.

The panel driver 30 may receive image data from the image processor 90 and drive the liquid crystal panel 20 according to the image data. In other words, the panel driver 30 may convert image data (hereinafter, referred to as ‘digital image data’) which is a digital signal into an analog image signal which is an analog voltage signal, and provide the converted analog image signal to the liquid crystal panel 20. Optical properties (for example, light transmittance) of the plurality of pixels included in the liquid crystal panel 20 may change according to the analog image signal.

The panel driver 30 may include, for example, a timing controller, a data driver, a scan driver, etc.

The timing controller may receive image data from the image processor 90 and output the image data and a driving control signal to the data driver and the scan driver. The driving control signal may include a scan control signal and a data control signal, and the scan control signal and the data control signal may be used to respectively control an operation of the scan driver and an operation of the data driver.

The scan driver may receive a scan control signal from the timing controller and input-activate any one of the plurality of rows in the liquid crystal panel 20 according to the scan control signal. In other words, the scan driver may convert pixels included in any row among the plurality of pixels arranged in the plurality of rows and the plurality of columns to a state capable of receiving an analog image signal. At this time, the other pixels input-deactivated, except for the pixels input-activated by the scan driver, may not receive an analog image signal.

The data driver may receive image data and a data control signal from the timing controller and output the image data to the liquid crystal panel 20 according to the data control signal. For example, the data driver may receive digital image data from the timing controller and convert the digital image data into an analog image signal. Also, the data driver may provide the analog image signal to pixels included in any row input-activated by the scan driver. At this time, the pixels input-activated by the scan driver may receive the analog image signal and optical properties (e.g., light transmittance) of the input-activated pixels may change according to the received analog image signal.

As described above, the panel driver 30 may drive the liquid crystal panel 20 according to the image data. Therefore, an image corresponding to the image data may be displayed on the liquid crystal panel 20.

The light source device 100 may include the plurality of light emitting devices 111 that emit light, and the plurality of light emitting devices 111 may be arranged in a matrix form. In other words, the plurality of light emitting devices 111 may be arranged in a plurality of rows and a plurality of columns. Also, the light emitting devices 111 may be divided into a plurality of dimming blocks 200, and each of the plurality of dimming blocks 200 may include at least one light emitting device 111.

The dimming driver 170 may receive dimming data from the image processor 90 and drive the light source device 100 according to the dimming data. The dimming data may include information about luminance of each of the plurality of dimming blocks 200 or information about luminance of light emitting devices 111 included in each of the plurality of dimming blocks 200.

The dimming driver 170 may convert dimming data (hereinafter, referred to as “‘digital dimming data”) that is a digital signal, into an analog dimming signal that is an analog voltage signal, and provide the analog dimming signal to the light source device 100. An intensity of light emitted from the light emitting devices 111 included in each of the plurality of dimming blocks 200 may change according to the analog dimming signal.

Particularly, the dimming driver 170 may provide the analog dimming signal sequentially to the plurality of dimming blocks 200 by an active matrix method, instead of directly providing the analog dimming signal to all of the plurality of dimming blocks 200.

As described above, the plurality of dimming blocks 200 may be arranged in a matrix form in the light source device 100. In other words, the plurality of dimming blocks 200 may be arranged in a plurality of rows and a plurality of columns in the light source device 100.

The dimming driver 170 may provide the analog dimming signal sequentially to dimming blocks belonging to the plurality of rows or to dimming blocks belonging to the plurality of columns.

For example, the dimming driver 170 may input-activate dimming blocks belonging to any row of the plurality of dimming blocks 200 and provide the analog dimming signal to the input-activated dimming blocks. Then, the dimming driver 170 may input-activate dimming block belonging to another row of the plurality of dimming blocks 200 and provide the analog dimming signal to the input-activated dimming blocks.

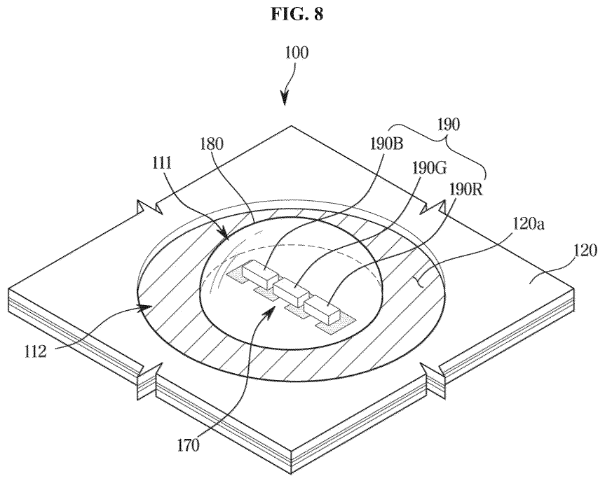

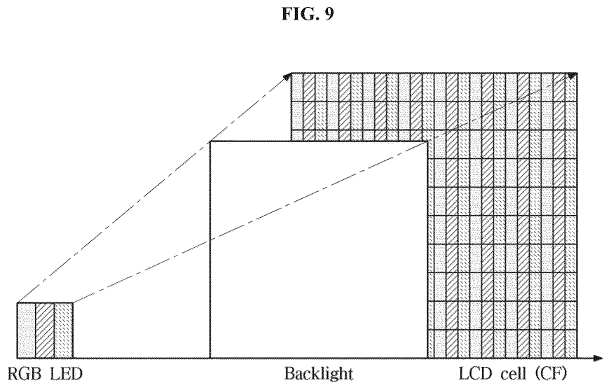

FIG. 8 shows an example of a light emitting device included in a backlight unit in a display apparatus according to an embodiment, and FIG. 9 is a view for describing an image output using a backlight unit that includes LEDs of a plurality of colors in a display apparatus according to an embodiment.

Referring to FIG. 8, each light emitting device 111 may include a LED group 170. That is, each light emitting device 111 may include a red LED 190R, a green LED 190G, and a blue LED 190B.

A plurality of LED groups 170 may be arranged in a two-dimensional matrix form on the upper surface of the substrate 112. That is, because the plurality of light emitting devices 111 are arranged in rows and columns, the plurality of LED groups 170 may be arranged in a two-dimensional matrix form.

Also, according to some embodiments, the plurality of light emitting devices 111 may be arranged such that three neighboring light emitting devices form substantially an equilateral triangle. In this case, one light emitting device may be adjacent to six light emitting devices. Also, distances between the light emitting device and the six adjacent light emitting devices may be substantially the same.

However, an arrangement of the plurality of light emitting devices 111 is not limited to the above-described arrangement, and the plurality of light emitting devices 111 may be arranged in various ways to emit light with uniform luminance.

Each light emitting device 111 may emit white light by including a red LED 190R, a green LED 190G, and a blue LED 190B.

Each of the plurality of light emitting devices 111 may include a LED group 170 and an optical dome 180.

The backlight unit 100 may have a small thickness such that the display apparatus 10 has a small thickness. To reduce the thickness of the backlight unit 100, each of the plurality of light emitting devices 111 may have a small thickness and a simple structure.

Each LED included in each LED group 170 may include a P-type semiconductor and an N-type semiconductor to emit light by recombination of holes and electrons. Also, the LED may include a pair of electrodes for supplying holes and electrons to the P-type semiconductor and the N-type semiconductor.

Each of the LEDs 190 (e.g., the red LED 190R, the green LED 190G, and the blue LED 190B) may be configured to convert electricity energy into optical energy. Each of the LEDs 190 (e.g., the red LED 190R, the green LED 190G, and the blue LED 190B) may emit light having a maximum strength in a preset wavelength based on supplied power. For example, the blue LED 190B may emit blue light having a peak value in a wavelength (e.g., a wavelength ranging from 430 nm to 495 nm) that displays a blue color.

For example, a multilayer reflective structure in which a plurality of insulating films having different refractive indices are alternately laminated may be provided on a front surface of each of the LEDs 190 (e.g., the red LED 190R, the green LED 190G, and the blue LED 190B). For example, the multilayer reflective structure may be configured as a distributed Bragg reflector (DBR). The DBR is a structure in which two or more materials having different refractive indices are alternately laminated and may be an optical device that has high reflectivity for light of a specific wavelength according to a principle of forming an optical path difference according to a wavelength to induce strong reflection in a specific frequency band.

Also, the LEDs 190 (e.g., the red LED 190R, the green LED 190G, and the blue LED 190B) of the LED group 170 may be attached directly to the substrate 112 by a chip on board (COB) method. For example, the light emitting device 111 may include at least one LED 190 formed by attaching a LED chip or a LED die directly to the substrate 112 without separate packaging.

The LED 190 may be manufactured in a flip chip type. The LED 190 of the flip chip type may be formed by welding, upon attaching a LED (a semiconductor device) to the substrate 112, an electrode pattern of a semiconductor device to the substrate 112 without using a middle medium, such as a metal lead (wire) or a ball grid array (BGA). As described above, by using neither a metal lead (wire) nor a ball grid array, the light emitting device 111 including the LED 190 of the flip chip type may be miniaturized.

As described above, the LED 190 of the flip chip type may be welded directly to the substrate 112 by the chip on board method. However, the light emitting device 111 is not limited to a LED of a flip chip type. For example, the light emitting device 111 may include a LED of a package type.

The optical dome 180 may cover the LED group 170. That is, the optical dome 180 may cover the red LED 190R, the green LED 190G, and the blue LED 190B, included in the LED group 170.

The optical dome 180 may refract red light, green light, and blue light respectively emitted from the red LED 190R, the green LED 190G, and the blue LED 190B to mix the red light, green light, and blue light, thereby emitting white light.

As described above, the optical dome 180 may emit white light by mixing red light, green light, and blue light, and reduce a distance for mixing to white light, compared to a case in which no optical dome 180 exists, thereby reducing an optical distance for changing point light sources to a surface light source.

Also, the optical dome 180 may prevent or suppress the LEDs 190 from being damaged by a mechanical action from outside and/or by a chemical action.

The optical dome 180 may be in a shape of a dome resulting from cutting such as, for example, a sphere with a plane not including a center of the sphere, or in a shape of a hemisphere resulting from cutting a sphere with a plane including a center of the sphere. A vertical section of the optical dome 180 may be in a shape of, for example, a segment of a circle or a semicircle.

The optical dome 180 may be formed of silicon or an epoxy resin. For example, the optical dome 180 may be formed by discharging molten silicon or a molten epoxy resin onto the LEDs 190 through a nozzle, etc., and then hardening the silicon or epoxy resin.

The optical dome 180 may be optically transparent or translucent. Light emitted from the LED 190 may pass through the optical dome 180 and be emitted to the outside.

The optical dome 180 being in a shape of a dome may refract the light, like a lens. For example, light emitted from the LEDs 190 may be refracted by the optical dome 180 and dispersed.

As described above, the optical dome 180 may protect the LEDs 190 from an external mechanical and/or chemical action or an electrical action, and disperse light emitted from the LEDs 190.

As described above, the optical dome 180 may be in a shape of a silicon dome. However, the light emitting device 111 is not limited to including the optical dome 180. For example, the light emitting device 111 may include a lens for dispersing light emitted from the LEDs 190.

As described above, the display apparatus 10 according to an embodiment of the present disclosure may include the light emitting devices 111 each having the red LED 190R, the green LED 190G, and the blue LED 190B, such that a local dimming operation in a color vision deficiency mode, which will be described later, may maximize an effect of a color vision deficiency filter while reducing unnecessary power consumption compared to a local dimming operation using a single light source. That is, compared to a display apparatus including a backlight unit having only blue LEDs and a Quantum Dot (QD) sheet, by using a backlight unit including the red LED 190R, the green LED 190G, and the blue LED 190B, the effect of a color vision deficiency filter in a color vision deficiency mode may be maximized while reducing unnecessary power consumption. In this case, a QD sheet may not be included as a component of the display apparatus.

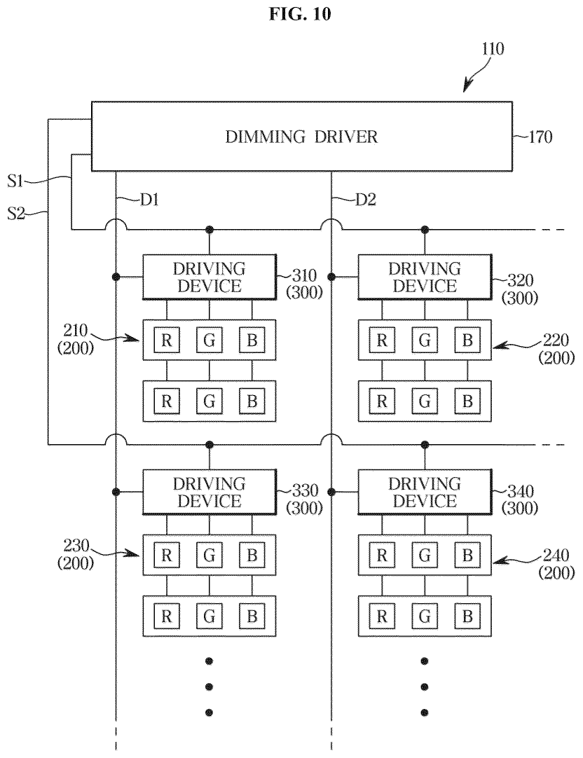

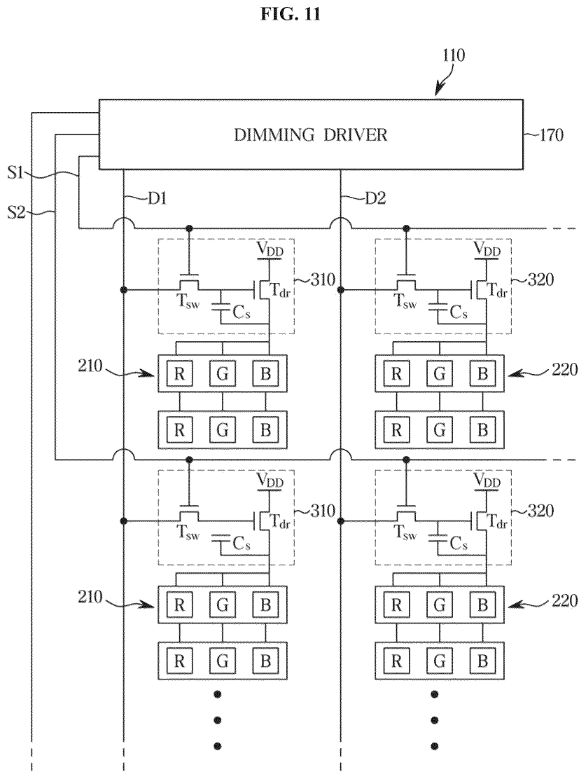

FIGS. 10 and 11 show an arrangement of a dimming driver, a driving device, and a light emitting device, included in a display apparatus according to an embodiment.

Referring to FIGS. 10 and 11, the display apparatus 10 may include the dimming driver 170, the plurality of driving devices 300 (e.g., a first driving device 310, a second driving device 320, a third driving device 330, and a fourth driving device 340), and the plurality of light emitting devices 111.

The plurality of light emitting devices 111 may include LEDs and may be divided into the plurality of dimming blocks 200. A plurality of light emitting devices 111 belonging to the same dimming block may form a group.

The plurality of light emitting devices 111 may receive an analog dimming signal from the dimming driver 170 and supply a driving current to the plurality of light emitting devices 111 according to the received analog dimming signal.

A plurality of light emitting devices belonging to one dimming block may receive current from the same driving device. For example, a plurality of light emitting devices belonging to a first dimming block 210 may receive driving current from a first driving device 310. A plurality of light emitting devices belonging to a second dimming block 220 may receive driving current from a second driving device 320. A plurality of light emitting devices belonging to a third dimming block 230 may receive driving current from a third driving device 330. A plurality of light emitting devices belonging to a fourth dimming block 240 may receive driving current from a fourth driving device 340. In the same way, a plurality of light emitting devices belonging to a n-th dimming block may receive driving current from a n-th driving device.

Therefore, a plurality of light emitting devices belonging to one dimming block may receive driving current having the same magnitude. Also, a plurality of light emitting devices belonging to one dimming block may emit light having the same intensity.

Also, the plurality of light emitting devices 111 belonging to one dimming block 200 may include the red LED 190R, the green LED 190G, and the blue LED 190B, and in this case, LEDs having the same color in a same dimming block may receive current from a same driving device along the same current supply line.

That is, each of the plurality of driving devices 300 may include a plurality of current supply lines for supplying driving current, and the current supply lines may be arranged to supply driving current to LEDs having the same color.

A current supply line extending from a driving device may be connected only to red LEDs, green LEDs, or blue LEDs, as shown in FIG. 10.

While the driving devices 300 are input-activated by the dimming driver 300, the driving devices 300 may receive an analog dimming signal from the dimming driver 170 and store the received analog dimming signal. Also, while the driving devices 300 are input-deactivated, the plurality of driving devices 300 may supply driving current corresponding to the stored analog dimming signal to the plurality of light emitting devices 111.

A plurality of scan lines (e.g., a first scan line S1 and a second scan line S2) for providing a scan signal from the dimming driver 170 to the plurality of driving devices 300 and a plurality of data lines (e.g., a first data line D1) and (a second data line D2) for providing an analog dimming signal from the dimming driver 170 to the plurality of driving devices 300 may be provided.

The plurality of dimming blocks 200 may be arranged in a plurality of rows and a plurality of columns. Driving devices that supply driving current to light emitting devices of dimming blocks belonging to the same row may share the same scan line. For example, the first driving device 310 and the second driving device 320 may share a first scan line S1, and the third driving device 330 and the fourth driving device 340 may share a second scan line S2.

Also, driving devices that supply driving current to light emitting devices of dimming blocks belonging to the same column may share the same data line. For example, the first driving device 310 and the third driving device 330 may share a first data line D1, and the second driving device 320 and the fourth driving device 340 may share a second data line D2.

The plurality of driving devices 300 may be input-activated by a scan signal from the dimming driver 170 and receive an analog dimming signal from the dimming driver 170.

For example, while the dimming driver 170 outputs a scan signal through the first scan line S1, the first driving device 310 and the second driving device 320 may receive an analog dimming signal through the first data line D1 and the second data line D2. Meanwhile, the third driving device 330 and the fourth driving device 340 may receive no analog dimming signal.

Also, while the dimming driver 170 outputs a scan signal through the second scan line S2, the third driving device 330 and the fourth driving device 340 may receive an analog dimming signal through the first data line D1 and the second data line D2. Meanwhile, the first driving device 310 and the second driving device 320 may receive no analog dimming signal.

According to reception of an analog dimming signal, the plurality of driving devices 300 may store the received analog dimming signal and supply driving current to a plurality of light emitting devices according to the stored analog dimming signal.

For example, while the dimming driver 170 outputs a scan signal through the first scan line S1, the third driving device 330 and the fourth driving device 340 may supply driving current to a plurality of light emitting devices included in the third dimming block 230 and the fourth dimming block 240.

Also, while the dimming driver 170 outputs a scan signal through the second scan line S2, the first driving device 310 and the second driving device 320 may supply driving current to a plurality of light emitting devices included in the first dimming block 210 and the second dimming block 220.

By such driving based on the active-matrix method, the plurality of driving devices 300 may receive an analog dimming signal sequentially from the dimming driver 170, and, even while the plurality of driving devices 300 are input-deactivated by receiving no analog dimming signal from the dimming driver 170, the plurality of driving devices 300 may supply driving current to the plurality of light emitting devices 111.

By the driving based on the active-matrix method, the number of pins of the dimming driver 170 for providing an analog dimming signal to the plurality of dimming blocks 200 may be reduced. Also, the number of signal lines for providing an analog dimming signal from the dimming driver 170 to the plurality of dimming blocks 200 may be reduced. Therefore, the number of dimming blocks may increase regardless of the number of the pins of the dimming driver 170.

The plurality of driving devices 300 may include various topology circuits to implement driving based on the active-matrix method.

For example, each of the plurality of driving devices 300 may include a one capacitor two transistor (1C2T) topology circuit.

Each of the plurality of driving devices 300 may include a driving transistor T_{dr}, a switching transistor T_{sw}, and a storage capacitor Cₛ.

The driving transistor T_{dr} may include an input terminal, an output terminal, and a control terminal. The input terminal of the driving transistor T_{dr} may be connected to a power source V_{dd} and the output terminal of the driving transistor T_{dr} may be connected to a plurality of light emitting devices. The driving transistor T_{dr} may supply driving current to the plurality of light emitting devices according to a voltage of the control terminal.

The storage capacitor Cₛ may be provided between the output terminal and the control terminal of the driving transistor T_{dr}. The storage capacitor Cₛ may store input charges and output a constant voltage. The driving transistor T_{dr} may supply driving current to the plurality of light emitting devices according to a voltage output from the storage capacitor Cₛ.

The switching transistor T_{sw} may also include an input terminal, an output terminal, and a control terminal. The input terminal of the switching transistor T_{sw} may be connected to a data line (e.g., the first data line D1 or the second data line D2) and the output terminal of the switching transistor T_{sw} may be connected to the control terminal of the driving transistor T_{dr}. The control terminal of the switching transistor T_{sw} may be connected to a scan line (e.g., the first scan line S1 or the second scan line S2).

The switching transistor T_{sw} may be turned on by a scan signal from the scan line (e.g., the first scan line S1 or the second scan line S2) and transfer an analog dimming signal from the data line (e.g., the first data line D1 or the second data line D2) to the storage capacitor Cₛ and the driving transistor T_{dr}. The analog dimming signal from the data line (e.g., the first data line D1 or the second data line D2) may be input to the control terminal of the driving transistor T_{dr}, and the driving transistor T_{dr} may supply driving current corresponding to the analog dimming signal to the plurality of light emitting devices. The storage capacitor Cₛ may store charges by the analog dimming signal and output a voltage corresponding to the analog dimming signal.

Thereafter, although the scan signal is no longer input and the switching transistor T_{sw} is turned off, the storage capacitor Cₛ may continue to output the voltage corresponding to the analog dimming signal, and the driving transistor T_{dr} may continue to supply the driving current corresponding to the analog dimming signal to the plurality of light emitting devices.

The circuit shown in FIG. 11 is only an example of the driving device 300 and embodiments of the present disclosure are not limited thereto. For example, the driving device 300 may include a one capacitor three transistor (3T1C) topology circuit to which a transistor for correcting a body effect of the driving transistor T_{dr} is added.

The driving device 300 may be provided as, for example, a single chip into which the circuit shown in FIG. 11 is integrated. In other words, the circuit shown in FIG. 11 may be integrated into a single semiconductor chip.

As described above, display apparatuses of comparative embodiments have used only blue LEDs, which have a high bandgap energy, as a light source. Red and green quantum dot (QD) particles, upon receiving energy from the blue light, convert the color to emit red light and green light, and these are combined to produce the three primary colors with high efficiency and high purity. In the comparative embodiments, only blue LEDs were used as the light source, and thus RGB color control has been primarily performed by a thin-film transistor (TFT) substrate, which adjusts the transmittance of a liquid crystal (LC) cell, and a color filter. Furthermore, a color vision deficiency filter function was also controlled by adjusting the transmittance of the liquid crystal in the LC cell stage and by the color filter.

For example, in comparative embodiments, a color vision deficiency filter function for a user with red color vision deficiency operates to express a stronger red light by increasing the current of the LEDs in the backlight unit and increasing the liquid crystal transmittance to enhance the red perception. In order to increase the luminance of the red light, there is a need to increase the current of the blue LEDs and increase the liquid crystal layer to allow stronger red light to pass through. Such a process leads to a decrease in luminous efficiency and an increase in power consumption due to the unnecessary emission of green and blue light. Moreover, when there is a limitation in increasing the LED current, red-series colors need to be significantly changed to purple by software processing to enhance the red-green color contrast, which distorted the original colors and hindered accurate color perception.

A display apparatus 10 according to an embodiment of the present disclosure may use RGB LEDs as a light source and, in a color vision deficiency mode, analyzes color differences for each video frame in real-time to control the current of the RGB LEDs for each dimming block, thereby implementing a color vision deficiency filter function that enhances color discrimination while being power-efficient. Accordingly, a user with color vision deficiency may recognize colors more clearly, thereby enhancing their visual experience, and overall power consumption may be reduced by applying a method of adjusting different current weights for each LED depending on the dimming block.

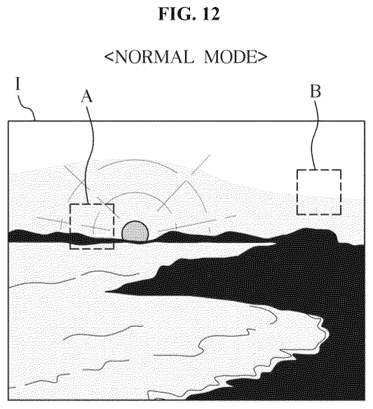

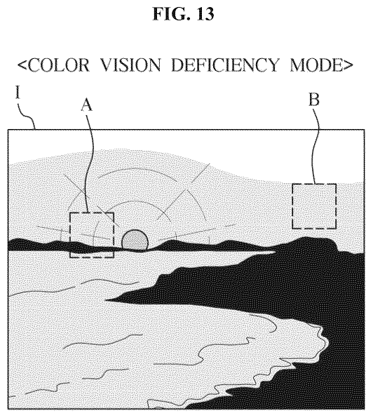

FIG. 12 shows an image block A and an image block B of an image in a normal mode of a display apparatus according to an embodiment, and FIG. 13 shows an image block A and an image block B of an image in a color vision deficiency mode of the display apparatus according to an embodiment.

Referring to FIG. 12 and FIG. 13, an image block A (an area) in an image I in a normal mode and an image block A in an image I in a color vision deficiency mode are the same area (the same image block).

An image block B in the image I in the normal mode and an image block B in the image I in the color vision deficiency mode are the same area (the same image block).

The image block A (the first area) may be a region where color distinction from adjacent (neighboring) blocks is difficult. The image block A may be a region where the color difference with an adjacent block is relatively small. The image block B (second area) may be a region where color distinction from adjacent (neighboring) blocks is relatively easy. The image block B may be a region where the color difference with an adjacent block is relatively large.

As the image mode changes from a normal mode, which is a normal viewing mode, to a color vision deficiency mode (e.g., a red color vision deficiency mode) in which a color vision deficiency filter function is activated, the at least one processor 91 (see FIG. 6) may adjust current values supplied to a red LED 190R, a green LED 190G, and a blue LED 190B of a first dimming block corresponding to the image block A (the first area) according to the type of the color vision deficiency mode, and may also adjust current values supplied to a red LED 190R, a green LED 190G, and a blue LED 190B of a second dimming block corresponding to the image block B (a second area) according to the type of the color vision deficiency mode.

The display apparatus 10 may be designed to output standard colors, but some users may not fully experience these colors due to color vision deficiency. For example, a user with red color vision deficiency has abnormal spectral sensitivity in the red-series range and thus perceives red-series light weaker than green-series and blue-series light. Accordingly, in the red color vision deficiency mode, a red color vision deficiency filter function may be provided to enable clear color discrimination by increasing the current of the red LED by an amount corresponding to the weak perception of red light, or by decreasing the current of the green LED or the blue LED while providing color correction to allow the user with red color vision deficiency to perceive the original sense of red as much as possible. Furthermore, a green color vision deficiency filter function and a blue color vision deficiency filter function may be provided in a manner similar to the manner of implementing the red color vision deficiency filter function.

The color vision deficiency mode may include a red color vision deficiency mode, a green color vision deficiency mode, a blue color vision deficiency mode, etc., according to the type of color vision deficiency. The color vision deficiency mode is not limited thereto and may include more various modes. The red color vision deficiency mode may provide a red color vision deficiency filter function that provides color correction to allow a user with red color vision deficiency to perceive the original sense of red as much as possible by increasing the current of the red LED, or by decreasing the current of the green LED or the blue LED. The green color vision deficiency mode may provide a green color vision deficiency filter function that provides color correction to allow a user with green color vision deficiency to perceive the original sense of green as much as possible by increasing the current of the green LED, or by decreasing the current of the red LED or the blue LED. The blue color vision deficiency mode may provide a blue color vision deficiency filter function that provides color correction to allow a user with blue color vision deficiency to perceive the original sense of blue as much as possible by increasing the current of the blue LED, or by decreasing the current of the red LED or the green LED.

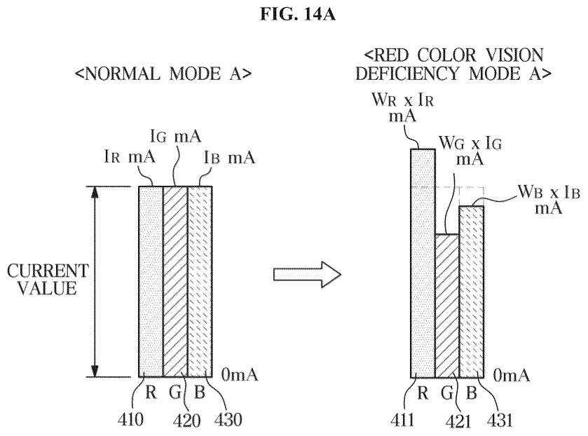

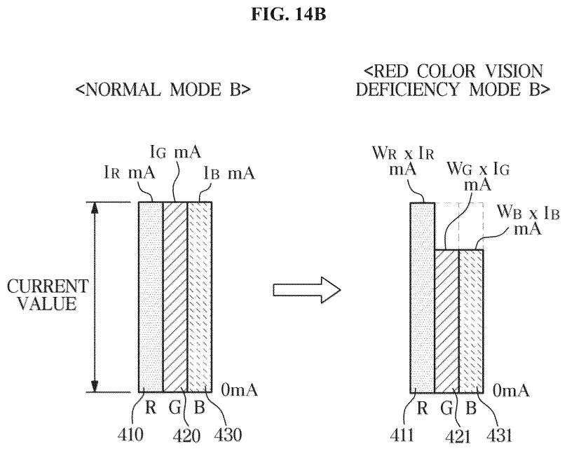

FIGS. 14A and 14B show changes in current values of RGB LEDs in image block A and image block B of an image in a normal mode and in a red color vision deficiency mode of a display apparatus according to an embodiment.

Referring to FIGS. 14A and 14B, an image block A (a first area) in the normal mode and an image block A in the red color vision deficiency mode are the same area. an image block B (a second area) in the normal mode and an image block B in the red color vision deficiency mode are the same area.

The image block A may be a region that is difficult for color distinction from an adjacent block due to having a relatively small color difference with the adjacent block. For example, the image block A may be a region with a red-series object on a red background.

The image block B may be a region that is easy for color distinction from an adjacent block due to having a relatively large color difference with the adjacent block. For example, the image block B may be a region with a red-series object on a blue background.

When the mode is changed from the normal mode to the red color vision deficiency mode, the current values supplied to the red LED 190R, the green LED 190G, and the blue LED 190B of a first dimming block corresponding to the image block A (the first area) in the normal mode may be changed to the current values supplied to the red LED 190R, the green LED 190G, and the blue LED 190B of the first dimming block corresponding to the image block A (the first area) in the red color vision deficiency mode.

Because the image block A is a region where distinction from adjacent colors is relatively difficult, as the mode changes from the normal mode to the red color vision deficiency mode, a current weight W_{R} of the red LED 190R may be set higher than a current weight W_{G} of the green LED 190G and a current weight W_{B} of the blue LED 190B for fine color distinction. In addition, along with this adjustment, the current weight WB of the blue LED may be increased slightly higher than the current weight W_{G} of the green LED 190G to correct luminance, thereby enhancing color discrimination ability.

Referring to FIG. 14A, current values supplied to a red LED 190R, a green LED 190G, and a blue LED 190B of a first dimming block corresponding to an image block A (the first area) according to image data in a normal mode are shown.

In the normal mode, according to the image data, the current value 410 supplied to the red LED 190R of the first dimming block corresponding to the image block A (the first area) may be I_{R} mA, the current value 420 supplied to the green LED 190G may be I_{G} mA, and the current value 430 supplied to the blue LED 190B may be I_{B} mA, wherein I_{R}, I_{G}, and I_{B} are the current values 410, 420, and 430, respectively, in milliamps (mA).

Also referring to FIG. 14A, current values supplied to the red LED 190R, green LED 190G, and blue LED 190B of the first dimming block corresponding to the image block A (the first area) according to image data in a red color vision deficiency mode are shown.

In the red color vision deficiency mode, according to the image data, the current value 411 supplied to the red LED 190R may be I_{R}×W_{R} mA, the current value 421 supplied to the green LED 190G may be I_{G}×W_{G} mA, and the current value 431 supplied to the blue LED 190B may be I_{B}×W_{B} mA, wherein the product of I_{R} and W_{R}, the product of I_{G} and W_{G}, and the product of I_{B} and W_{B} are the current values 411, 421, and 431, respectively, in milliamps (mA).

For example, the current weights W_{R}, W_{G}, and W_{B} for the red LED 190R, the green LED 190G, and the blue LED 190B of the first dimming block corresponding to the image block A (the first area) may be 1.2, 0.75, and 0.9, respectively. That is, when a default value of the current weight is 1, the current weight W_{R} may be a value increased by 20% from the default value, the current weight W_{G} may be a value decreased by 25% from the default value, and the current weight W_{B} may be a value decreased by 10% from the default value. Each current weight is not limited to the above numerical values and may be implemented in various forms.

Accordingly, based on the image data, the current value supplied to the red LED 190R of the first dimming block corresponding to the image block A (the first area) may be I_{R}×1.2 mA, the current value supplied to the green LED 190G may be I_{G}×0.75 mA, and the current value supplied to the blue LED 190B may be I_{B}×0.9 mA.

As described above, for a region, such as the image block A (the first area), where distinction from adjacent colors is relatively difficult, the current weight W_{R} of the red LED 190R may be set higher than the current weight W_{G} of the green LED 190G and the current weight W_{B} of the blue LED 190B in the red color vision deficiency mode, thereby allowing a user with red color vision deficiency to perform fine color distinction. The color discrimination capability may be enhanced by setting the current weight of the blue LED to be higher than the current weight of the green LED 190G to correct luminance.

Furthermore, because the image block B (the second area) is a region where distinction from adjacent colors is relatively easy, as the mode changes from the normal mode to the red color vision deficiency mode, the current weight W_{G} of the green LED 190G and the current weight W_{B} of the blue LED 190B may be lowered compared to the red LED 190R to reduce power consumption. Since a user with red color vision deficiency perceives the red channel more weakly than the green and blue channels, for example, at a level of 0.75, the current values of the green LED 190G and the blue LED 190B may be lowered to 0.75 in reversely for correction.

Referring to FIG. 14B, in the normal mode, according to the image data, the current value 410 supplied to the red LED 190R of the second dimming block corresponding to the image block B (the second area) may be I_{R} mA, the current value 420 supplied to the green LED 190G may be I_{G} mA, and the current value 430 supplied to the blue LED 190B may be I_{B} mA, wherein I_{R}. I_{G}, and I_{B} are the current values 410, 420, and 430, respectively, in milliamps (mA) . . . .

In the red color vision deficiency mode, according to the image data, the current value 411 supplied to the red LED 190R of the second dimming block corresponding to the image block B (the second area) may be I_{R}× W_{R} mA, the current value 421 supplied to the green LED 190G may be I_{G}×W_{G} mA, and the current value 431 supplied to the blue LED 190B may be I_{B}×W_{B} mA, wherein the product of I_{R} and W_{R}, the product of I_{G} and W_{G}, and the product of I_{B} and W_{B} are the current values 411, 421, and 431, respectively, in milliamps (mA).

For example, the current weights W_{R}, W_{G}, and W_{B} for the red LED 190R, the green LED 190G, and the blue LED 190B of the second dimming block corresponding to the image block B (the second area) may be 1.0, 0.75, and 0.75, respectively. That is, when a default value of the current weight is 1, the current weight W_{R} is a value that maintains the default value, and both the current weights W_{G} and W_{B} may be values decreased by 25% from the default value. Each current weight is not limited to the above numerical values and may be implemented in various forms.

Accordingly, according to the image data, the current value supplied to the red LED 190R of the second dimming block corresponding to the image block B (the second area) may be I_{R}×1.0 mA, the current value supplied to the green LED 190G may be I_{G}×0.75 mA, and the current value supplied to the blue LED 190B may be I_{B}×0.75 mA.

As described above, for a region, such as the image block B (the second area), where distinction from adjacent colors is relatively easy, the current weight W_{G} of the green LED 190G and the current weight W_{B} of the blue LED 190B may be lowered compared to the current weight W_{R} of the red LED 190R in the red color vision deficiency mode, thereby improving the color perception of a user with red color vision deficiency while reducing excessive current usage and thus reducing power consumption.

As described above, the display apparatus 10 according to an embodiment of the present disclosure may implement a power-efficient color vision deficiency filter by obtaining the color difference with surrounding blocks and inputting different current weights according to the local dimming area to adjust dimming data. That is, by implementing the color vision deficiency filter through differently adjusting the current weights of the RGB LEDs for each dimming block based on comparison of color values with adjacent areas, local dimming control for each color channel may be performed using the RGB LEDs, and power consumption may be reduced along with more precise RGB color control by dividing areas for color vision deficiency filtering and correcting colors.

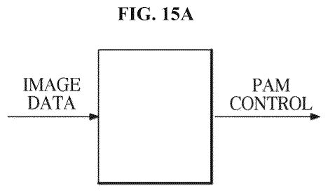

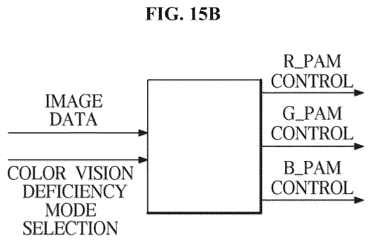

FIGS. 15A and 15B are views for comparing operations of performing local dimming in a display apparatus according to an embodiment.

Referring to FIGS. 15A and 15B, controlling the current supplied to the red LED 190R, the green LED 190G, and the blue LED 190B based on the current weights according to the type of color vision deficiency mode selected by the user and the image data may be performed through pulse amplitude modulation (PAM) control. PAM control may control the luminance of each LED by fixing the pulse width and varying only the amplitude at regular intervals. Through PAM control, the brightness of the light from the red LED 190R, the green LED 190G, and the blue LED 190B may be adjusted by controlling the current of each LED according to the image data and the current weights.

As shown in FIG. 15A, according to a comparative embodiment, a backlight unit including a single-color light source is used, and the color vision deficiency filter function is implemented through PAM control for the single-color light source.

As shown in FIG. 15B, according to an embodiment of the present disclosure, a backlight unit 100 that uses RGB LEDs as a light source may be provided, and may more effectively implement the color vision deficiency filter function by determining different current weights of each LED for each dimming block through comparison of color values with adjacent areas, and controlling supply of currents applied with the current weights to each LED through PAM control.

After controlling the current supplied to each LED for each dimming block, PWM control may be additionally performed for each LED to adjust the brightness.

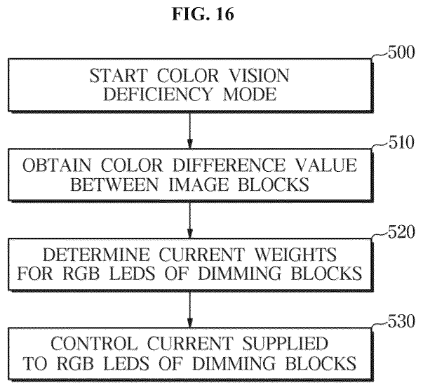

FIG. 16 shows an example of a flowchart of a method of controlling a display apparatus according to an embodiment.

Referring to FIG. 16, the at least one processor 91 may start a color vision deficiency mode (operation 500).

The at least one processor 91 may start the color vision deficiency mode in response to a user selecting the color vision deficiency mode.

In response to the color vision deficiency mode being started, the at least one processor 91 may obtain a color difference value between a plurality of image blocks corresponding to a plurality of dimming blocks based on image data (operation 510).

The at least one processor 91 may determine a current weight of at least one from among the red LED 190R, the green LED 190G, and the blue LED 190B of the plurality of dimming blocks based on the color difference value between the plurality of image blocks (operation 520).

The at least one processor 91 may control the current supplied to at least one from among the red LED 190R, the green LED 190G, and the blue LED 190B of the plurality of dimming blocks based on the image data and the current weight.

The at least one processor 91 may determine the current weights of the RGB LEDs of the dimming blocks corresponding to the image blocks based on the type of the color vision deficiency mode and the color difference value between the image blocks. The type of the color vision deficiency mode may include information about the type of color vision mode, such as a red color vision deficiency mode, a green color vision deficiency mode, or a blue color vision deficiency mode.

Accordingly, the display apparatus 10 according to an embodiment of the present disclosure uses RGB LEDs as a light source and, in a color vision deficiency mode, analyzes color differences for each video frame in real-time to control the currents of the RGB LEDs for each dimming block, thereby implementing a power-efficient color vision deficiency filter function with high color discrimination. This may enhance the visual experience by enabling a user with color vision deficiency to perceive colors more clearly, and may reduce overall power consumption by applying a method of differently adjusting the current weight for each LED according to the dimming block.

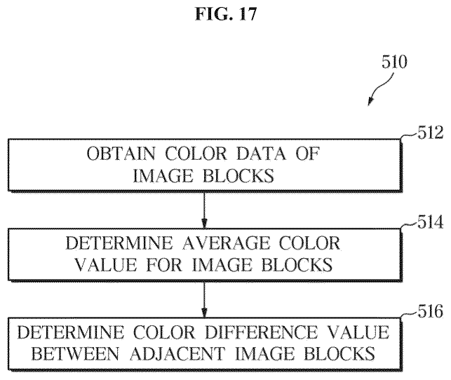

FIG. 17 shows an example of a flowchart for obtaining color difference data in a display apparatus according to an embodiment.

Referring to FIG. 17, the at least one processor 91 may obtain color data of pixels included in a plurality of image blocks corresponding to a plurality of dimming blocks based on image data (operation 512).

The at least one processor 91 may collect the color data of each pixel as RGB coordinate values.

The at least one processor 91 may sum all RGB values of image blocks corresponding to dimming blocks based on the collected RGB values.

The at least one processor 91 may determine an average color value for each image block (x, y) by averaging the summed RGB values (operation 514).

The at least one processor 91 may determine a color difference value between adjacent image blocks among the plurality of image blocks by comparing the average color values of the adjacent image blocks (operation 516).

The RGB model may classify colors as a combination of three components: red R, green G, and blue B. In the RGB model, R, G, and B may each have a value between 0 and 255. In the RGB model, the color difference value between two color points, (R1, G1, B1) and (R2, G2, B2), may be calculated using the Euclidean distance d.

Specifically, the Euclidean distance d corresponding to the color difference value between the two points may be obtained by the following Equation [1].

$$d = \sqrt{{( R 1 - R 2 )}^{2} + {( G 1 - G 2 )}^{2} + {( B 1 - B 2 )}^{2}} \qquad [ Equation 1 ]$$

The at least one processor 91 may generate a color difference value (δE) by calculating the color difference between adjacent blocks, and may increase the color contrast that a person with color vision deficiency may perceive through the color difference value.

For example, when a first image block (2,2) and a second image block (2,3) are neighboring image blocks, and the average color value of the first image block (2,2) is (200, 150, 100), and the average color value of the second image block (2,3) is (180, 160, 120), the color difference value (8E2.2.2.3) may be calculated as follows:

$$δ {E}_{2 , 2 , 2 , 3} = \sqrt{{( 200 - 180 )}^{2} + {( 150 - 160 )}^{2} + {( 100 - 120 )}^{2}} = 30$$

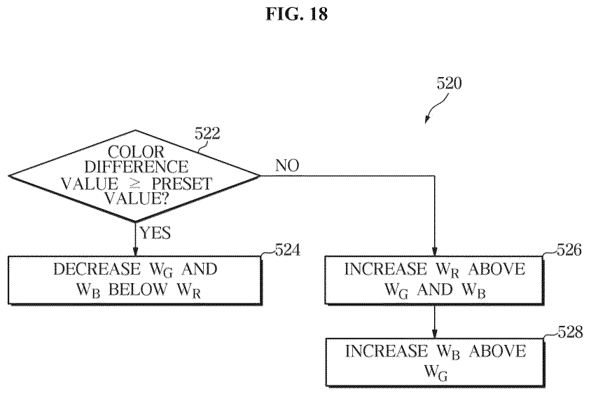

FIG. 18 is shows an example of a flowchart for determining current weights in a display apparatus according to an embodiment.

Referring to FIG. 18, the at least one processor 91 may determine (e.g., cause) the current weight W_{R} of the red LED 190R to be a higher value than the current weight W_{G} of the green LED 190G and the current weight W_{B} of the blue LED 190B in the plurality of dimming blocks 200 based on the color vision deficiency mode being a red color vision deficiency mode.

First, based on the color vision deficiency mode being the red color vision deficiency mode, the at least one processor 91 may determine whether a color difference value between an image block and an adjacent image block exceeds a preset value (operation 522).

Based on the color difference value between the image block and the adjacent image block exceeding the preset value (YES in operation 522), the at least one processor 91 may reduce the current weight W_{G} of the green LED 190G and the current weight W_{B} of the blue LED 190B of a dimming block 200 corresponding to the image block to be lower than the current weight W_{R} of the red LED 190R (524).

As in the image block B (second area) of FIG. 14, when the color difference value with respect to adjacent image blocks exceeds the preset value, the corresponding image block is a region relatively easy for color distinction from adjacent image blocks. Accordingly, the current weight W_{G} of the green LED 190G and the current weight W_{B} of the blue LED 190B may be lowered compared to the red LED 190R, to reduce power consumption.

For example, the current weights W_{R}, W_{G}, and W_{B} for the red LED 190R, the green LED 190G, and the blue LED 190B of the dimming block corresponding to the image block B (the second area) may be 1.0, 0.75, and 0.75, respectively. That is, when a default value of the current weight is 1, the current weight W_{R} is a value that maintains the default value, and both the current weights W_{G} and W_{B} may be values decreased by 25% from the default value.

As described above, in the red color vision deficiency mode, by lowering the current weight W_{G} of the green LED 190G and the current weight W_{B} of the blue LED 190B compared to the current weight W_{R} of the red LED 190R, the color perception of a user with red color vision deficiency may be improved while reducing power consumption.

Furthermore, based on the color difference value between the image block and the adjacent image block being less than or equal to the preset value (NO in operation 522), the at least one processor 91 may increase the current weight W_{R} of the red LED 190R of the dimming block 200 corresponding to the image block to be higher than the current weight W_{G} of the green LED 190G and the current weight W_{B} of the blue LED 190B (526). Accordingly, a user with red color vision deficiency may perform fine color distinction. At this time, the at least one processor 91 may increase the current weight W_{B} of the blue LED to be higher than the current weight W_{G} of the green LED 190G (operation 528). Accordingly, luminance may be corrected, thereby enhancing color discrimination capability.

As in the image block A (first area) of FIG. 14, when the color difference value with respect to adjacent image blocks is less than or equal to the preset value (NO in operation 522), the corresponding image block is a region relatively difficult for color distinction from adjacent image blocks. Accordingly, the current weight W_{R} of the red LED 190R may be increased to be higher than the current weight W_{G} of the green LED 190G and the current weight W_{B} of the blue LED 190B, and the current weight W_{B} of the blue LED may be increased to be higher than the current weight W_{G} of the green LED 190G to enable fine color distinction for a user with red color vision deficiency and enhance color discrimination ability. At this time, the reduction ratio of the current weight W_{B} of the blue LED 190B may be set to be lower than the reduction ratio of the current weight W_{G} of the green LED 190G.

For example, the current weights W_{R}, W_{G}, and W_{B} for the red LED 190R, the green LED 190G, and the blue LED 190B of the first dimming block corresponding to the image block A (the first area) may be 1.2, 0.75, and 0.9, respectively. That is, when a default value of the current weight is 1, the current weight W_{R} may be a value increased by 20% from the default value, the current weight W_{G} may be a value decreased by 25% from the default value, and the current weight W_{B} may be a value decreased by 10% from the default value.

As described above, in the red color vision deficiency mode, by increasing the current weight W_{R} of the red LED 190R to be higher than the current weight W_{G} of the green LED 190G and the current weight W_{B} of the blue LED 190B, and also increasing the current weight W_{B} of the blue LED to be higher than the current weight W_{G} of the green LED 190G, fine color distinction and enhanced color discrimination capability for a user with red color vision deficiency are possible.

Furthermore, based on the color difference value between the image block and the adjacent image block being less than or equal to the preset value (NO in operation 522), the at least one processor 91 may set the current weight W_{R} of the red LED 190R of the dimming block 200 corresponding to the image block as a first current weight, and based on the color difference value exceeding the preset value (YES in operation 522), the at least one processor 91 may set the current weight W_{R} of the red LED 190R of the corresponding dimming block 200 as a second current weight. At this time, the first current weight may be a value greater than the second current weight. Accordingly, the red color sense of a region where color distinction from an adjacent image block is relatively difficult may be enhanced compared to the red color sense of a region where color distinction from an adjacent image block is relatively easy.

In addition, the at least one processor 91 may cause the current weight W_{G} of the green LED 190G to be a higher value than the current weight W_{R} of the red LED 190R and the current weight W_{B} of the blue LED 190B in the plurality of dimming blocks 200 based on the color vision deficiency mode being a green color vision deficiency mode.

Based on the color difference value between the image block and the adjacent image block exceeding the preset value, the at least one processor 91 may reduce the current weight W_{R} of the red LED 190R and the current weight W_{B} of the blue LED 190B of a dimming block 200 corresponding to the image block to be lower than the current weight W_{G} of the green LED 190G.

For example, the current weights W_{R}, W_{G}, and W_{B} for the red LED 190R, the green LED 190G, and the blue LED 190B may be 0.75, 1.0, and 0.75, respectively. That is, when a default value of the current weight is 1, the current weight W_{G} is a value that maintains the default value, and both the current weights W_{R} and W_{B} may be values decreased by 25% from the default value.

As described above, in the green color vision deficiency mode, by lowering the current weight W_{R} of the red LED 190R and the current weight W_{B} of the blue LED 190B compared to the current weight W_{G} of the green LED 190G, the color perception of a user with green color vision deficiency may be improved while reducing power consumption.

Furthermore, based on the color difference value between the image block and the adjacent image block being less than or equal to the preset value, the processor 91 may increase the current weight W_{G} of the green LED 190G of the dimming block 200 corresponding to the image block to be higher than the current weight W_{R} of the red LED 190R and the current weight W_{B} of the blue LED 190B. Accordingly, a user with green color vision deficiency may perform fine color distinction. At this time, the at least one processor 91 may increase the current weight W_{B} of the blue LED to be higher than the current weight W_{R} of the red LED 190R. Accordingly, luminance may be corrected, thereby enhancing color discrimination capability.

When the color difference value with respect to adjacent image blocks is less than or equal to the preset value, the corresponding image block is a region relatively difficult for color distinction from adjacent image blocks. Accordingly, the current weight W_{G} of the green LED 190G may be increased to be higher than the current weight W_{R} of the red LED 190R and the current weight W_{B} of the blue LED 190B, and the current weight W_{B} of the blue LED may be increased to be higher than the current weight W_{R} of the red LED 190R to enable fine color distinction for a user with green color vision deficiency and enhance color discrimination ability. At this time, the reduction ratio of the current weight W_{B} of the blue LED 190B may be set to be lower than the reduction ratio of the current weight W_{R} of the red LED 190R.

For example, the current weights W_{R}, W_{G}, and W_{B} for the red LED 190R, the green LED 190G, and the blue LED 190B may be 0.75, 1.2, and 0.9, respectively. That is, when a default value of the current weight is 1, the current weight W_{G} may be a value increased by 20% from the default value, the current weight W_{R} may be a value decreased by 25% from the default value, and the current weight W_{B} may be a value decreased by 10% from the default value.

As described above, in the green color vision deficiency mode, by increasing the current weight W_{G} of the green LED 190G to be higher than the current weight W_{R} of the red LED 190R and the current weight W_{B} of the blue LED 190B, and also increasing the current weight W_{B} of the blue LED to be higher than the current weight W_{R} of the red LED 190R, fine color distinction and enhanced color discrimination capability for a user with green color vision deficiency are possible.

Furthermore, based on the color difference value between the image block and the adjacent image block being less than or equal to the preset value, the at least one processor 91 may set the current weight W_{G} of the green LED 190G of the dimming block 200 corresponding to the image block as a first current weight, and based on the color difference value exceeding the preset value, the processor 91 may set the current weight W_{G} of the green LED 190G of the corresponding dimming block 200 as a second current weight. At this time, the first current weight may be a value greater than the second current weight. Accordingly, the green color sense of a region where color distinction from an adjacent image block is relatively difficult may be enhanced compared to the green color sense of a region where color distinction from an adjacent image block is relatively easy.

In addition, the at least one processor 91, based on the color vision deficiency mode being a blue color vision deficiency mode, may set the current weight W_{G} of the green LED 190G, the current weight W_{R} of the red LED 190R, and the current weight W_{B} of the blue LED 190B of the plurality of dimming blocks 200 in the same manner as in the red color vision deficiency mode or the green color vision deficiency mode.

Furthermore, the at least one processor 91 may set the current weight W_{G} of the green LED 190G, the current weight W_{R} of the red LED 190R, and the current weight W_{B} of the blue LED 190B of the plurality of dimming blocks 200 in a similar manner according to various color vision deficiency modes.

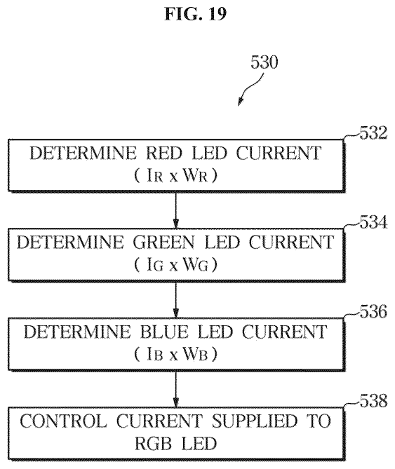

FIG. 19 shows an example of a flowchart for controlling current of RGB LEDs by applying current weights in a display apparatus according to an embodiment.

Referring to FIG. 19, the at least one processor 91 may determine the current for the red LED 190R by applying the current weight W_{R} of the red LED 190R for each dimming block (operation 532).

The at least one processor 91 may determine the current for the green LED 190G by applying the current weight W_{G} of the green LED 190G for each dimming block (operation 534).

The at least one processor 91 may determine the current for the blue LED 190B by applying the current weight W_{B} of the blue LED 190B for each dimming block (operation 536).

The at least one processor 91 may control the current values supplied to the red LED 190R, the green LED 190G, and the blue LED 190B of each dimming block through PAM control such that the current values of the red LED 190R, the green LED 190G, and the blue LED 190B of each dimming block reach the determined current values (operation 538).

Accordingly, the display apparatus 10 according to an embodiment of the present disclosure may use RGB LEDs as a light source and, in a color vision deficiency mode, analyze color differences for each video frame in real-time to control the current of the RGB LEDs for each dimming block, thereby implementing a power-efficient color vision deficiency filter function with high color discrimination.

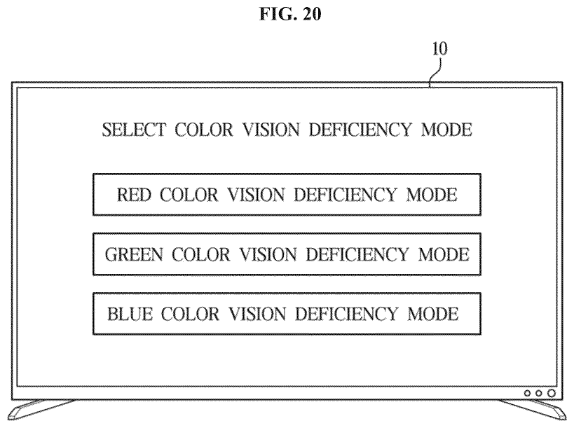

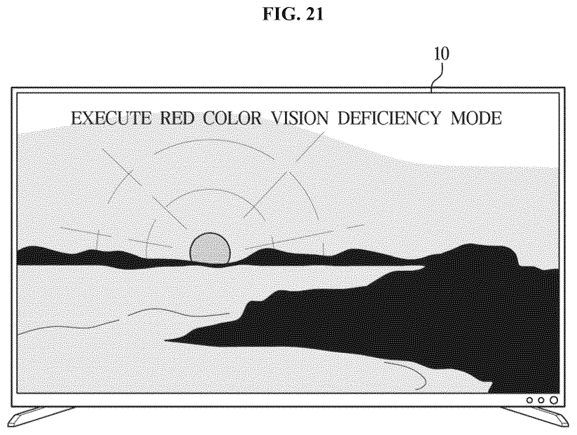

FIG. 20 is a view for describing selection of a color vision deficiency mode in a display apparatus according to an embodiment, and FIG. 21 is a view for describing execution of a color vision deficiency mode in a display apparatus according to an embodiment.

Referring to FIG. 20 and FIG. 21, the display apparatus 10 may further include an inputter for receiving a user input. The user may input a user command to the inputter through an external device such as a remote controller or a separate manipulator provided on the display apparatus 10.

The at least one processor 91 may select a color vision deficiency mode in the image mode based on a user command received through the inputter.

The display apparatus 10 may provide a user interface for receiving a selection of a desired color vision deficiency mode from the user. When the user inputs a command to select a color vision deficiency mode by manipulating an external device such as a remote controller, the at least one processor 91 may execute the selected color vision deficiency mode.

The color vision deficiency mode may be classified into a red color vision deficiency mode, a green color vision deficiency mode, a blue color vision deficiency mode, etc., according to the type of color vision deficiency. The user may select one of these modes to set an image mode suitable for the user's color vision deficiency.

The red color vision deficiency mode is designed for people who have difficulty distinguishing red, and may adjust the color contrast to change the hue of the screen such that red is more clearly distinguished.

The green color vision deficiency mode may be adjusted to help users who have difficulty distinguishing green to better recognize colors related to green.

The blue color vision deficiency mode may appropriately adjust the screen colors to increase the contrast of blue to help users who have difficulty perceiving blue.

A person with color vision deficiency may select and execute a color vision deficiency mode that matches the person's color vision deficiency characteristics, thereby enabling the person to watch images with appropriate color sense.

For example, when the red color vision deficiency mode is selected, the red color vision deficiency mode may be immediately activated to adjust the colors on the screen, which may help a user with red color vision deficiency to distinguish colors more clearly. Through this adjustment, the user with red color vision deficiency may easily access various color-based information, and the user experience may be enhanced.

As described above, the display apparatus 10 according to an embodiment of the present disclosure may implement an efficient color vision deficiency filter by independently controlling dimming data for each LED by adjusting the current weights of the RGB LEDs differently according to the color value difference with adjacent blocks. Since increasing the LED current of a specific color that a person with color vision deficiency finds difficult to perceive may be required, the current of each LED may be optimized according to the image by relatively increasing the current weight of the corresponding LED in areas where color distinction is difficult and relatively lowering the current weight of the corresponding LED in areas where distinction is relatively easy. For example, in a case where the majority of areas are composed of colors that are easy to distinguish, energy efficiency may be increased by flexibly setting a lower current weight for those areas.

The display apparatus 10 according to an embodiment of the present disclosure may implement a color vision deficiency filter function that controls the current of RGB LEDs for each dimming block through real-time color difference analysis. By analyzing and adjusting the color data and current weights in real-time according to the image, the display apparatus may always provide the user with optimal color perception and a power-efficient color vision deficiency filter function. By optimizing the color difference between image blocks, the apparatus may provide a clear color perception experience according to the type of color vision deficiency of the person, and may maximize energy efficiency by reducing unnecessary current consumption and intensively distributing current to certain areas. In addition, the apparatus may reduce unnecessary power loss and provide a high level of visual experience to a person with color vision deficiency through more precise color control.

According to some embodiments of the present disclosure, a display apparatus 10 may use RGB LEDs as a light source and, in a color vision deficiency mode, analyze color differences for each video frame in real-time to control the current of the RGB LEDs for each dimming block, thereby implementing a power-efficient color vision deficiency filter function with high color discrimination. Accordingly, the visual experience may be enhanced by enabling a user with color vision deficiency to perceive colors more clearly, and overall power consumption may be reduced by applying a method of differently adjusting the current weight for each LED according to the dimming block.

A display apparatus 10 according to an embodiment of the present disclosure may include: an image display portion 20; a backlight unit 100 configured to provide light to the image display portion 20; and at least one processor 91 configured to control the image display portion 20 and the backlight unit 100, wherein the backlight unit 100 comprises: a substrate 112; and a plurality of dimming blocks 200 arranged in a plurality of rows and a plurality of columns on the substrate 112, the plurality of dimming blocks 200 each including a red light-emitting diode (LED) 190R, a green LED 190G, and a blue LED 190B, and wherein, in a color vision deficiency mode, the at least one processor 91 is configured to: obtain a color difference value between a plurality of image blocks IB corresponding to the plurality of dimming blocks 200, based on image data; determine a current weight of at least one from among the red LED 190R, the green LED 190G, and the blue LED 190B of the plurality of dimming blocks 200, based on the color difference value between the plurality of image blocks IB; and control a current supplied to the at least one from among the red LED 190R, the green LED 190G, and the blue LED 190B of the plurality of dimming blocks 200, based on the image data and the current weight.

The at least one processor 91 may be further configured to determine an average color value for each of the plurality of image blocks IB based on color data of pixels P included in the plurality of image blocks IB; and determine a color difference value between image blocks adjacent to each other among the plurality of image blocks IB by comparing the average color values of the adjacent image blocks among the plurality of image blocks IB.

The at least one processor 91 may be further configured to, based on the color vision deficiency mode being a red color vision deficiency mode, determine a current weight of the red LED 190R to be greater than current weights of the green LED 190G and the blue LED 190B of the plurality of dimming blocks 200.

The at least one processor 91 may be further configured to, based on a color difference value between an image block and an adjacent image block among the plurality of image blocks being less than or equal to a preset value, determine a current weight of a red LED 190R of a dimming block 200 corresponding to the image block as a first current weight; and based on the color difference value exceeding the preset value, determine the current weight of the red LED 190R as a second current weight, wherein the first current weight is greater than the second current weight.

Based on a color difference value between an image block and an adjacent image block among the plurality of image blocks being less than or equal to a preset value, the at least one processor 91 may be further configured to increase a current weight of a red LED 190R of a dimming block 200 corresponding to the image block to be higher than a default value, and decrease current weights of a green LED 190G and a blue LED 190B of the corresponding dimming block to be lower than the default value.

A reduction ratio of the current weight of the blue LED 190B may be lower than a reduction ratio of the current weight of the green LED 190G.

Based on a color difference value between an image block and an adjacent image block among the plurality of image blocks IB exceeding the preset value, the at least one processor 91 may be further configured to maintain a current weight of a red LED 190R of a dimming block 200 corresponding to the image block at a default value, and decrease current weights of a green LED 190G and a blue LED 190B of the corresponding dimming block to be lower than the default value.

The at least one processor 91 may be further configured to determine a current value for the at least one from among the red LED 190R, the green LED 190G, and the blue LED 190B of the plurality of dimming blocks 200 based on the image data and the current weight; and supply the determined current value to the at least one from among the red LED 190R, the green LED 190G, and the blue LED 190B of the plurality of dimming blocks 200 through Pulse Amplitude Modulation (PAM) control.

Based on the color vision deficiency mode being a green color vision deficiency mode, the at least one processor 91 may be further configured to determine the current weight of the green LED 190G of the plurality of dimming blocks 200 to be a value greater than current weights of the red LED 190R and the blue LED 190B.

The at least one processor 91 may be further configured to, based on a color difference value between an image block and an adjacent image block among the plurality of image blocks being less than or equal to a preset value, determine a current weight of a green LED 190G of a dimming block 200 corresponding to the image block as a first current weight; and based on the color difference value exceeding the preset value, determine the current weight of the green LED 190G as a second current weight, wherein the first current weight is greater than the second current weight.

Based on a color difference value between an image block and an adjacent image block among the plurality of image blocks IB being less than or equal to a preset value, the at least one processor 91 may be further configured to increase a current weight of a green LED 190G of a dimming block 200 corresponding to the image block to be higher than a default value, and decrease current weights of a red LED 190R and a blue LED 190B of the corresponding dimming block to be lower than the default value.

A reduction ratio of the current weight of the blue LED 190B may be lower than a reduction ratio of the current weight of the red LED 190R.

Based on a color difference value between an image block and an adjacent image block among the plurality of image blocks exceeding the preset value, the at least one processor 91 may be further configured to maintain a current weight of a green LED 190G of a dimming block 200 corresponding to the corresponding image block at a default value, and decrease current weights of a red LED 190R and a blue LED 190B of the corresponding dimming block to be lower than the default value.

A method of controlling a display apparatus 10 according to an embodiment of the present disclosure may include: in a color vision deficiency mode, obtaining a color difference value between a plurality of image blocks IB corresponding to a plurality of dimming blocks 200 based on image data, determining a current weight of at least one from among a red light-emitting diode (LED) 190R, a green LED 190G, and a blue LED 190B of the plurality of dimming blocks 200, based on the color difference value between the plurality of image blocks; and controlling a current supplied to the at least one from among the red LED 190R, the green LED 190G, and the blue LED 190B of the plurality of dimming blocks 200, based on the image data and the current weight.

The obtaining of the color difference value may include obtaining color data of pixels P included in the plurality of image blocks IB; determining an average color value for each of the plurality of image blocks IB; and determining a color difference value between image blocks adjacent to each other among the plurality of image blocks IB by comparing the average color values of the adjacent image blocks among the plurality of image blocks IB.

Embodiments of the present disclosure may be embodied in the form of a recording medium storing instructions executable by a computer. The instructions may be stored in the form of program code and, when executed by at least one processor, may cause the at least one processor perform the operations of the embodiments of the present disclosure. The recording medium may be embodied as a computer-readable recording medium.

The computer-readable recording medium includes all kinds of recording media in which instructions which may be decoded by a computer are stored such as, for example, a Read Only Memory (ROM), a Random Access Memory (RAM), a magnetic tape, a magnetic disk, a flash memory, an optical data storage device, and the like.

The computer-readable recording storage medium may be provided in the form of a non-transitory storage medium. Here, when a storage medium is referred to as “non-transitory,” it can be understood that the storage medium is tangible and does not include a signal (electromagnetic waves), but rather that data is semi-permanently or temporarily stored in the storage medium. For example, a “non-temporary storage medium” may include a buffer in which data is temporarily stored.

According to an embodiment, the methods according to the various embodiments described herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

Although non-limiting example embodiments of the present disclosure have been described with reference to the accompanying drawings, those skilled in the art will appreciate that embodiments of the present disclosure may be embodied in different forms without departing from the scope and spirit of the present disclosure, and should not be construed as limited to the example embodiments set forth herein.

What is claimed is:

1. A display apparatus, comprising:
an image display portion;
a backlight unit configured to provide light to the image display portion; and
at least one processor configured to cause the display apparatus to display an image by controlling the image display portion and the backlight unit,
wherein the backlight unit comprises:
a substrate; and
a plurality of dimming blocks arranged in a plurality of rows and a plurality of columns on the substrate, the plurality of dimming blocks each comprising a red light-emitting diode (LED), a green LED, and a blue LED, and
wherein, in a color vision deficiency mode, the at least one processor is configured to:
obtain, based on image data, a color difference value between a plurality of image blocks of the image, the plurality of image blocks corresponding to the plurality of dimming blocks;
determine at least one from among a current weight of the red LED of a dimming block from among the plurality of dimming blocks, a current weight of the green LED of the dimming block, and a current weight of the blue LED of the dimming block, based on the color difference value between the plurality of image blocks; and
control a current supplied to the at least one from among the red LED of the dimming block, the green LED of the dimming block, and the blue LED of the dimming block, based on the image data and the current weight that is determined.

2. The display apparatus of claim 1, wherein the color difference value obtained by the at least one processor is a color difference value between adjacent image blocks from among the plurality of image blocks, and
the at least one processor is further configured to:
determine average color values for the adjacent image blocks, respectively, based on color data of pixels included in the adjacent image blocks; and
determine the color difference value between the adjacent image blocks by comparing the average color values of the adjacent image blocks.

3. The display apparatus of claim 1, wherein the at least one processor is further configured to, based on the color vision deficiency mode being a red color vision deficiency mode, cause the current weight of the red LED to be greater than the current weight of the green LED and the current weight of the blue LED.

4. The display apparatus of claim 3, wherein
the color difference value obtained by the at least one processor is a color difference value between a first image block and a second image block adjacent to the first image block,
the at least one processor is further configured to:
based on the color difference value between the first image block and the second image block being less than or equal to a preset value, determine the current weight of the red LED of the dimming block as a first current weight, wherein the dimming block corresponds to the first image block; and
based on the color difference value exceeding the preset value, determine the current weight of the red LED as a second current weight, and
the first current weight is greater than the second current weight.

5. The display apparatus of claim 3, wherein
the color difference value obtained by the at least one processor is a color difference value between a first image block and a second image block adjacent to the first image block,
the at least one processor is further configured to, based on the color difference value between the first image block and the second image block being less than or equal to a preset value, increase the current weight of the red LED of the dimming block to be higher than a default value, and decrease the current weight of the green LED of the dimming block and the current weight of the blue LED of the dimming block to be lower than the default value, and
the dimming block corresponds to the first image block.

6. The display apparatus of claim 5, the at least one processor is further configured to, based on the color difference value between the first image block and the second image block being less than or equal to the preset value, cause the current weight of the green LED of the dimming block to be lower than the current weight of the blue LED of the dimming block.

7. The display apparatus of claim 3, wherein
the color difference value obtained by the at least one processor is a color difference value between a first image block and a second image block adjacent to the first image block,
the at least one processor is further configured to:
based on a color difference value between the first image block and the second image block exceeding a preset value, maintain the current weight of the red LED of the dimming block at a default value, and decrease the current weight of the green LED of the dimming block and the blue LED of the dimming block to be lower than the default value, and
the dimming block corresponds to the first image block.

8. The display apparatus of claim 1, wherein the at least one processor is further configured to:
determine a current value of at least one from among the red LED of the dimming block, the green LED of the dimming block, and the blue LED of the dimming block based on the image data and the current weight that is determined; and
supply the current value to the at least one from among the red LED, the green LED, and the blue LED through Pulse Amplitude Modulation (PAM) control.

9. The display apparatus of claim 1, wherein the at least one processor is further configured to, based on the color vision deficiency mode being a green color vision deficiency mode, cause the current weight of the green LED to be a value greater than the current weight of the red LED and the current weight of the blue LED.

10. The display apparatus of claim 9, wherein
the color difference value obtained by the at least one processor is a color difference value between a first image block and a second image block adjacent to the first image block,
the at least one processor is further configured to:
based on the color difference value between the first image block and the second image block being less than or equal to a preset value, determine the current weight of the green LED of the dimming block as a first current weight, wherein the dimming block corresponds to the first image block; and
based on the color difference value exceeding the preset value, determine the current weight of the green LED as a second current weight, and
the first current weight is greater than the second current weight.

11. The display apparatus of claim 9, wherein,
the color difference value obtained by the at least one processor is a color difference value between a first image block and a second image block adjacent to the first image block,
the at least one processor is further configured to, based on the color difference value between the first image block and the second image block being less than or equal to a preset value, increase the current weight of the green LED of the dimming block to be higher than a default value, and decrease the current weight of the red LED of the dimming block and the blue LED of the dimming block to be lower than the default value, and
the dimming block corresponds to the first image block.

12. The display apparatus of claim 11, wherein the at least one processor is further configured to, based on the color difference value between the first image block and the second image block being less than or equal to the preset value, cause the current weight of the red LED of the dimming block to be lower than the current weight of the blue LED of the dimming block.

13. The display apparatus of claim 9, wherein
the color difference value obtained by the at least one processor is a color difference value between a first image block and a second image block adjacent to the first image block,
the at least one processor is further configured to, based on a color difference value between the first image block and the second image block exceeding a preset value, maintain the current weight of the green LED of the dimming block at a default value, and decrease the current weight of the red LED of the dimming block and the current weight of the blue LED of the dimming block to be lower than the default value, and
the dimming block corresponds to the first image block.

14. A method of controlling a display apparatus to display an image, the method comprising:
obtaining, in a color vision deficiency mode and based on image data, a color difference value between a plurality of image blocks of the image, the plurality of image blocks corresponding to a plurality of dimming blocks of the display apparatus, and the plurality of dimming blocks each including a red light-emitting diode (LED), a green LED, and a blue LED;
determining at least one from among a current weight of the red LED of a dimming block from among the plurality of dimming blocks, a current weight of the green LED of the dimming block, and a current weight of the blue LED of the dimming block, based on the color difference value between the plurality of image blocks; and
controlling a current supplied to the at least one from among the red LED of the dimming block, the green LED of the dimming block, and the blue LED of the dimming block, based on the image data and the current weight that is determined.

15. The method of claim 14, wherein the color difference value that is obtained is a color difference value between adjacent image blocks from among the plurality of image blocks, and
the obtaining the color difference value comprises:
obtaining color data of pixels included in the adjacent image blocks;
determining average color values of the adjacent image blocks, respectively; and
determining the color difference value between the adjacent image blocks by comparing the average color values of the adjacent image blocks.

16. A display apparatus, comprising:
a plurality of groups of light-emitting diodes (LEDs), each of the plurality of groups of LEDs comprising a red LED, a green LED, and a blue LED; and
at least one processor configured to cause the display apparatus to display an image by controlling the plurality of groups of LEDs,
wherein, in a color vision deficiency mode, the at least one processor is configured to:
obtain, based on image data, a color difference value between a plurality of image blocks of the image, the plurality of image blocks corresponding to the plurality of groups of LEDs;
determine at least one from among a current weight of the red LED of a LED group from among the plurality of groups of LEDs, a current weight of the green LED of the LED group, and a current weight of the blue LED of the LED group, based on the color difference value between the plurality of groups of LEDs; and
control a current supplied to the at least one from among the red LED of the LED group, the green LED of the LED group, and the blue LED of the LED group, based on the image data and the current weight that is determined.

17. The display apparatus of claim 16, wherein the color difference value obtained by the at least one processor is a color difference value between adjacent image blocks from among the plurality of image blocks, and
the at least one processor is further configured to:
determine average color values for the adjacent image blocks, respectively, based on color data of pixels included in the adjacent image blocks; and
determine the color difference value between the adjacent image blocks by comparing the average color values of the adjacent image blocks.

18. The display apparatus of claim 16, wherein
the at least one processor is further configured to, based on the color vision deficiency mode being a red color vision deficiency mode, cause the current weight of the red LED to be greater than the current weight of the green LED and the current weight of the blue LED.

19. The display apparatus of claim 18, wherein
the color difference value obtained by the at least one processor is a color difference value between a first image block and a second image block adjacent to the first image block,
the at least one processor is further configured to:
based on the color difference value between the first image block and the second image block being less than or equal to a preset value, determine a current weight of the red LED of the LED group as a first current weight, wherein the LED group corresponds to the first image block; and
based on the color difference value exceeding the preset value, determine the current weight of the red LED as a second current weight, and
the first current weight is greater than the second current weight.

20. The display apparatus of claim 18, wherein
the color difference value obtained by the at least one processor is a color difference value between a first image block and a second image block adjacent to the first image block,
the at least one processor is further configured to, based on the color difference value between the first image block and the second image block being less than or equal to a preset value, increase the current weight of the red LED of the LED group to be higher than a default value, and decrease the current weight of the green LED of the LED group and the blue LED of the LED group to be lower than the default value, and
the dimming block corresponds to the first image block.
